(19) United States
(12) Patent Application Publication
(10) Pub. No.: US 2009/0242301 A1
(43) Pub. Date: Oct. 1, 2009

(54) Efficient Vehicle Power Systems

(76) Inventors: Robert F. McClanahan, Valencia, CA (US); Robert D. Washburn, Malibu, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/060,820

(22) Filed: Apr. 1, 2008

(51) Int. Cl. B60K 5/08

(52) U.S. Cl. 180/69.6

(57) ABSTRACT

The present disclosure teaches a fuel efficient method for powering a vehicle. The total peak power requirements for a moving vehicle under a set of performance criteria are divided into at least two subgroups. A primary engine is provided with a size and output to provide for the peak power for one of the at least two subgroups and one or more auxiliary engines or auxiliary engine subsystems are provided with a size and output to provide for up to the peak power for the remaining one or more subgroups.

### FIELD

This disclosure relates generally to motive power systems and more particularly to a method, system and process for improving efficiency by matching power to load requirements during motive vehicular use.

### BACKGROUND

For a typical moving vehicle at lower speed levels, rolling resistance is a predominant loss mechanism providing a nearly linear relationship between power increases and speed increases as shown in the typical power versus speed profile for a vehicle under an operating condition set forth in FIG. 1. At higher speed levels, air drag becomes a factor as well and those losses show a non-linear relationship. A well-accepted measure of vehicle fuel efficiency for automobiles is and has traditionally been “miles per gallon” (MPG). Since the shape of the curve in FIG. 1 is dominated by external factors, improvements have translated into increased fuel efficiency. Examples include improved aerodynamics to reduce high-speed drag and less vehicle weight to reduce rolling resistance.

FIG. 2 illustrates typical engine efficiency versus engine output power under an operating condition. A level of output power is required to maintain engine operation, a portion of which is used internal to the engine. Fuel injection has improved combustion control and, together with improved materials and manufacturing capability, has allowed equivalent power production in physically smaller engines, often with fewer cylinders. Resulting fuel efficiency improvements have been somewhat offset by pollution control requirements that typically reduce overall fuel efficiency.

Traditional automobile power systems are functionally depicted in FIG. 3, and have remained largely unchanged since the internal combustion engine (ICE) became the industry standard in the early 1900s. The inclusion of a fuel consuming auxiliary engine that (if operated in conjunction with a main engine) consumes fuel, in addition to the fuel consumed by a main engine, for selectively powering one or more devices or systems such as a pump, heater, generator or an air conditioner is known.

Traditional vehicle power systems similar to those depicted in FIG. 3 are a determinant to the fuel efficiency. FIG. 2 shows the typical efficiency of internal combustion engines as a function of said engine output power. Maximum efficiency is achieved as the engine approaches but at a point below maximum engine output power capability.

### DEFINITIONS

Very Small Engine (VSE) means a subset of auxiliary engine, which has an output that is small compared to the maximum total output power required of the auxiliary engine system.

Controller means a device that controls operation of a motor or other device by supplying the motor or other device with one or more control signals or electrical power forms. (Control signal or electrical power form characteristics that provide control can include but are not limited to voltage, current, frequency, phase, impedance, and duty factor.)

Main Engine means the internal combustion engine that provided power for all loads of a conventional vehicle power system. A characteristic of a main engine is that its size and output is determined by the total peak power needs for a vehicle. Primary Engine means an engine, whether it be the sole engine or one of a plurality of power producing engines, having an output power that when combined with the auxiliary engine system output power is not less than the output power of a main engine and, which has a fuel efficiency, when combined together with the auxiliary engine(s) fuel efficiency that is not less than the fuel efficiency of a main engine where each of the main engine, and the primary engine plus auxiliary engine(s) is operating at its respective highest fuel efficiency.

Auxiliary Engine means a non-primary engine characterized by maximum output power substantially less than either the maximum output power of the primary engine or the maximum output power of the complete vehicle power system.

Auxiliary Engine System means the set comprised of all vehicle auxiliary engine subsystems, a central computer/controller, if any, for controlling either auxiliary engine arrays or individual auxiliary engine subsystems, and any supporting components, systems or structures for said auxiliary engine subsystems or central computer/controller.

Auxiliary Engine Subsystem means an auxiliary engine and any engine controller, supporting components, systems or structures, which are dedicated to the auxiliary engine and its operation.

Auxiliary Engine Array means a subset of auxiliary engine system comprised of one or more auxiliary engine subsystems sharing a common functionality with respect to vehicle operation, and any supporting components, systems or structures dedicated to said subset auxiliary engines, their operation and their collective functionality.

Motive Loads means a load directly related to providing power to vehicle wheels, propellers or props.

Non-Motive Loads means all loads that are not motive loads.

Engine Loads means a subset of non-motive loads internal to an engine and which an auxiliary engine cannot power independently.

Engine Support Non-Motive Loads means a subset of non-motive loads, which are external to the engine and support engine function.

Other Non-Motive Loads means a subset of non-motive loads, which do not support engine function.

Auxiliary Subsystems means systems that produce other non-motive loads.

Engine Subsystems means systems that produce engine loads.

Engine Support Subsystems means systems that produce engine support non-motive loads.

### SUMMARY

The loads 104 affecting the efficient use of fuel in a vehicle (see FIG. 3) vary during use, topography, distance, time, weather, and speed in response to a variety of real world driving conditions. For purposes of this disclosure, the loads have been group in limited ways in a number of exemplary implementations to illustrate a method and system of to match and balance the load to power ratio for all loads, a subset of a group of loads and for both substantially fixed and substantially variable loads. The groupings are not intended to be limiting. Those of ordinary skill in the art will recognize that a plethora of possible grouping combinations may be developed without departing from the scope of the disclosure. One division is illustrated in FIG. 4. Loads 104 are divided into motive loads 105 and non-motive auxiliary loads 106 (which are the non-motive loads that are not located internal to main engine 102). Non-motive auxiliary loads 105 may be further divided into Engine support non-motive loads 108 (such as water pump 306) and other non-motive loads 110 (such as A.C. compressor 310). Other non-motive loads may be grouped into variable RPM loads 112 and fixed RPM loads 114.

In the past only a few non-motive loads 106 were present, comprising engine loads and engine support loads 108 necessary to operate the engine. Today, in addition to the engine loads and engine support loads 108, one will find a plethora of other non-motive loads 110 devoted to computers, imaging, telemetry, lighting, communications, navigation, individual occupant environmental control, entertainment systems, electric seat heaters, defoggers plug-in charging for the gamut of electronic devices, power assisted windows, seats, steering, braking, and suspension stabilization, all of which are loads on the vehicle power system.

The explosion of non-motive auxiliary loads found in modern vehicles calls into question the very concept of whether MPG remains an accurate measure of fuel efficiency. These auxiliary loads have increased to a point where a significant amount of fuel is consumed providing power for these auxiliary loads 112. As illustrated in FIG. 5, activation of an auxiliary load such as the air conditioning compressor will both increase engine output power and reduce vehicle fuel economy. Additionally, as illustrated in FIGS. 6A & 6B off-peak engine loads are far below that of peak power output. Yet a conventional power system utilizes an engine with sufficient potential to individually deliver peak power. The fuel efficiency of such an engine is low when that engine is providing power for off-peak engine loads. Stated in a slightly different fashion, conventional vehicle power systems, operated under off-peak conditions, will require only a small fraction of their maximum power output.

Total fuel consumption (gallons, pounds, etc.) should not be confused with engine efficiency or fuel efficiency. Fuel consumed is greatest at maximum power output, and is substantially greater than that consumed under typical loading, which in turn is substantially greater than that consumed at minimum loading (engine at idle with no vehicle motion and no auxiliary systems functioning other than those required for the engine to operate).

An efficient vehicle power system (EVPS) can be viewed as one which, under identical loading (operating and/or performance criteria), consumes significantly less fuel than a conventional power, system of equal output power capability. Another characteristic of an EVPS is that larger reductions in fuel consumption coincide with the most frequently encountered loading conditions (typical or average loading). For example, based on the engine efficiency and fuel consumption characteristics described above, an EVPS could be configured such that under typical loading (operating and/or performance criteria), power was provided by a small engine (comparably sized to the typical load). This small engine should therefore have both high efficiency and low fuel consumption for typical vehicle loading). Output power from said small engine could be combined with that produced from a large engine (one capable of producing maximum peak output power required from the power system), which operates at or near neutral throttle unless and until power is required which is in excess of the capacity of said small engine.

The present disclosure is an efficient vehicle power system for converting potential energy stored within any of a wide variety of chemical molecules (fuel) into useful work wherein said conversion occurs over a wide, dynamic range of system operating loads, and where typical (average) system load power is substantially below the peak output power capability of said conversion system. The present disclosure describes power conversion for a wide variety of portable and mobile applications which addresses matching between power source characteristics and load conditions

Conventional vehicle power system efficiency characteristics are illustrated in FIG. 6A as they relate to the output power range of the system and the power required for vehicle operation under typical (average) conditions. The superior profile EVPS has a wider range of output power (at both maximum and minimum output power levels) and increased efficiency everywhere compared to the present art. At maximum power, the combined maximum power from both the large and small engines is greater than that from the single large engine. Fuel efficiency is improved everywhere across the range of power outputs because the more fuel efficient small engine provides a portion of the load power ranging from a large portion at low power system output to a smaller portion at high power system output. Furthermore, the greatest percentage improvement, represented by difference between the curves, is in the region representing typical vehicle operation.

The present disclosure is an EVPS for converting potential energy stored within any of a wide variety of chemical molecules (fuel) into useful work wherein said conversion occurs over a wide, dynamic range of system operating loads, and where typical (average) system load power is substantially below the peak output power capability of said conversion system. Exemplary implementations of the present disclosure provide low cost realization of efficiency profiles that conform to the superior profile of FIG. 6B. The present disclosure describes power conversion for a wide variety of portable and mobile applications and addresses matching between power source characteristics and load conditions.

In some exemplary implementations, one or more small, high efficiency auxiliary engines are in a EVPS. The one or more auxiliary engines partially unload the primary engine, allowing it to operate using less fuel, except when the total vehicle power requirement exceeds the capacity of the auxiliary engines. The primary engine is available to at least provide power in excess of the auxiliary engines capacity as needed, for example under conditions that might include heavy vehicle loading, rapid vehicle acceleration, and uphill travel. However, in many instances the primary engine is downsized whereby the fuel consumption of one or more auxiliary engines and the primary engine is less than or equal to the consumption of fuel by a single traditional main engine.

In some exemplary implementations, the present disclosure matches the different loads or combinations of loads to the available engine or engines thereby utilizing the fuel more efficiently.

In some exemplary implementations, the present disclosure includes two or more engines whose combined output power equals or exceeds that of a conventional single engine using identical fuel and providing power to identical vehicle loads, and where at least one of the multiple engines has lower maximum output power capability than the single engine.

In some exemplary implementations, the present disclosure includes two or more engines whose combined output power equals or exceeds that of a single conventional engine using identical fuel and providing power to identical vehicle loads, and where at least one of the multiple engines has higher fuel efficiency per unit of power produced (in some known output range) than that of the single conventional engine producing the same power in the same known range.

In some exemplary implementations, vehicle fuel efficiency is improved by more closely matching the output power capability of one or more power sources to individual load requirements at the point in time when the required load power is being delivered.

In some exemplary implementations of the present disclosure, auxiliary engines are configured such that power delivered to one or more auxiliary subsystems is independent of operating conditions of the mobility producing portion of the present disclosure.

In some exemplary implementations, one or more small capacity engines provide substantially all vehicle mobility power under vehicle operating conditions substantially less than full power.

In some exemplary implementations, an EVPS uses mechanical means for combining output power from two or more engines. Typically, said mechanical means are the crankshaft of the primary engine or a multiple electric motor, common rotor assembly for vehicles wherein mobility power is delivered by multiple electric motors.

In some exemplary implementations, an EVPS uses electrical means for combining output power from two or more engines. Typically, said electrical means are electrical alternators, driven by auxiliary ICEs, which are designed to operate with their outputs connected in parallel, and are configured to operate in a master-slave mode.

In some exemplary implementations, one or more small capacity engines provide a substantial portion of vehicle mobility power under vehicle operating conditions substantially less than full power.

In some exemplary implementations, no output power from any on-board fuel-consuming engine is coupled to the vehicle wheel drive system via direct mechanical connection.

In some exemplary implementations, output power from at least one auxiliary engine is converted to electrical power used, at least in part, to power electric motors for producing vehicle motion.

In one aspect of this disclosure, a vehicle has two or more electric motors providing mechanical drive power to the vehicle wheel drive system, the motors having a common rotor shaft assembly.

In some exemplary implementations of the present disclosure incorporating means for storing electrical energy sufficient to provide maximum power to vehicle loads, the required duration of maximum power delivery from said means of electrical energy storage is typically minimal, rarely more than a few minutes. The limited duration permits substantial reductions in the size, weight and cost of said means of electrical energy storage compared to present art AEVs and HEVs.

In some exemplary implementations, an array of very small engines (VSEs), with combined output power capacity sufficient to provide maximum power required for vehicle operation, forms an EVPS. In some aspects, a controller turns-on and turns-off one or more VSEs in the array responsive to anticipated power requirements calculated from data related to condition and status of said vehicle, route information location, and external environmental data. In some aspects, one or more sensors for acquisition of data useful for an onboard controller (which may include a computer) to calculate or to use a precalculated look-up-table (LUT) to determine near term vehicle power needs and establish a vehicle power system operating configuration (VPSOC} to provide for that power need.

In some exemplary implementations, the present disclosure operates using a fuel selected from the group including all hydrocarbon containing fuels, gasoline, diesel, ethanol, E-85, propane, liquefied natural gas, hydrogen, and other synthetic, blended or bio-fuels.

In some exemplary implementations, the present disclosure is of a fuel efficient method for powering a vehicle, the method comprising identifying the total peak power requirements for a vehicle under a set of performance criteria. Dividing the total peak power requirements into at least two subgroups. Utilizing a primary engine of a size and output to provide for the peak power for one of the at least two subgroups, and utilizing one or more auxiliary engines of a size and output to provide for the peak power for the remaining one or more subgroups.

In some aspects of the present disclosure, the primary engine has superior fuel efficiency than a single main engine would have when operating over the same defined range.

In some aspects of the present disclosure, the one or more auxiliary engines have superior fuel efficiency than a single main engine would have when operating over the same defined range.

In some aspects of the present disclosure, the combined fuel efficiency of the primary engine and the auxiliary engine system are superior to a main engine operating over the same defined range.

In some aspects of the present disclosure, at least one of the auxiliary engines operates at a substantially fixed RPM.

In some exemplary implementations, the present disclosure is of a fuel efficient method for powering a vehicle, comprising identifying the total peak load requirements for a terrestrial vehicle under a set of operating criteria. Divide the identified load requirements under the operating criteria into at least two groups. Use one or more auxiliary engine subsystems within the terrestrial vehicle to provide power for the load requirements of at least one group. Use a primary engine within the terrestrial vehicle to provide power for the remaining load requirements, wherein the combined fuel efficiency of the primary engine and the one or more auxiliary engine systems under the operating criteria is superior to the fuel efficiency of a single main engine utilized to provide for the peak load requirements of the vehicle.

In some aspects of the present disclosure, operating criteria include at least one of a distance and a time component.

In some aspects of the present disclosure, over a portion of at least one of time and distance the one or more auxiliary engine systems are, for some portion of time or distance, operating at less than full power.

In some aspects of the present disclosure, the primary engine provides power for at least motive loads; and, the power output of the at least one of the one or more auxiliary engine systems may be selectively combined with the power output of the primary engine.

In some exemplary implementations of the present disclosure, a load matching method for powering an automobile is disclosed. The method comprising identifying the total motive and non-motive loads for a vehicle under a set of performance criteria. Divide the total loads, which may require power within a automobile during powered movement, into at least two subgroups. Provide a primary engine, within the automobile, of a size and with a power output sufficient to provide for at least the motive loads; and provide one or more auxiliary engine subsystems, within the automobile, of a size and with an power output sufficient, to provide for non-motive loads which are not provided for by the primary engine.

OK In some exemplary implementations of the present disclosure, a fuel efficient system for powering an automobile is disclosed. The system comprising a primary engine of a size and output to supply the power for a predetermined portion of the automobile's power requirements which is less than 100% of the power requirements and an auxiliary engine system of a size and output to supply the power for the remaining portion of the automobile's power requirements.

In some aspects of the present disclosure, the primary engine and auxiliary engine system have superior fuel efficiency than a single main engine with a power supply capacity equal to the combined primary engine and auxiliary engine system when operating over the same defined range.

In some aspects of the present disclosure, the auxiliary engine system comprises at least two auxiliary engines.

In some exemplary implementations of the present disclosure, an improved fuel efficiency automotive power system is disclosed. The system comprising an automobile with a primary engine, and an auxiliary engine system wherein the combined “K” value for the primary engine and the auxiliary engine system is lower than the “K” value for a main engine with the same capacity during operation of the automobile.

In some aspects of the present disclosure, during operation of the system the motive power demands of the automobile on the average are between about 5 and about 95 percent of the capacity of the primary engine.

In some aspects of the present disclosure, during operation of the system the motive power demands of the automobile on the average are between about 10 and about 90 percent of the capacity of the primary engine.

In some aspects of the present disclosure, during operation of the system the non-motive power demands of the automobile on the average are between about 5 and about 95 percent of the capacity of the primary engine.

In some aspects of the present disclosure, non-motive power demands of the automobile is up to about 90 percent of the capacity of the auxiliary engine system.

The features and aspects of the present disclosure will be better understood from the following detailed descriptions, taken in conjunction with the accompanying drawings, all of which are given by illustration only, and are not limitative of the present disclosure.

### DRAWINGS

The above-mentioned features and objects of the present disclosure will become more apparent with reference to the following description taken in conjunction with the accompanying drawings wherein like reference numerals denote like elements and in which:

FIG. 1 is a graphical illustration of engine output power versus vehicle speed for a typical, ICE powered automobile, operating under steady state conditions.

FIG. 2 is a graphical illustration of engine efficiency versus engine output power for a typical vehicle ICE.

FIG. 3 is a block diagram of a conventional vehicle power system.

FIG. 4 is a block diagram showing load details for the vehicle power system of FIG. 3.

FIG. 5 is a graphical illustration of the change in vehicle MPG and engine output power as a result of operation or non-operation of an optional auxiliary load.

FIG. 6A a graphical illustration of the region of typical (average) output power superimposed upon the graphical illustration of FIG. 2.

FIG. 6B is a graphical illustration of a superior profile for power system efficiency versus power system output power superimposed upon the graphical illustration of FIG. 6A.

FIG. 7 is a block diagram of an efficient vehicle power system.

FIG. 8 is a block diagram of a specific, conventional, automobile power system.

FIG. 9 is a schematic illustration of typical belt and pulley means of power distribution to non-motive loads other than engine loads as implemented for the specific, conventional, automobile power system of FIG. 8.

FIG. 10 is a block diagram of an auxiliary engine subsystem and auxiliary belt drive system.

FIG. 11 is a block diagram of an exemplary implementation having a single auxiliary engine subsystem and a single drive belt providing power to motive and non-motive loads.

FIG. 12 is a block diagram of an exemplary implementation of an auxiliary engine subsystem and an auxiliary belt drive system of FIG. 11.

FIG. 13 is a block diagram of an exemplary implementation of a power system with a single auxiliary engine subsystem powering only a selection of non-motive loads.

FIG. 14A is a block diagram of an aspect of the auxiliary engine and the auxiliary belt drive subsystems of FIG. 13.

FIG. 14B is a block diagram of an aspect the auxiliary drive subsystem of FIG. 16.

FIG. 15 is a block diagram of an exemplary implementation of a power system with dual auxiliary engines and dual drive belts.

FIG. 16 is a block diagram of one exemplary implementation of a power system with dual auxiliary engine subsystems, a single drive belt to power non-motive loads, and a single electric motor to deliver power directly for producing vehicle motion.

FIG. 17 is a block diagram of one exemplary implementation of a power system using electric motor drive for producing vehicle motion.

FIG. 18 is a block diagram of one exemplary implementation of the power system of FIG. 17 with a single electric motor drive for producing vehicle motion.

FIG. 19 is a block diagram of one exemplary implementation of the power system of FIG. 17 having an array of electric motors to directly deliver power for producing vehicle motion.

FIG. 20 is a block diagram of one exemplary implementation of primary electric motor array and controllers function of FIG. 19.

FIG. 21A is a portion of the block diagram of FIG. 20 illustrating the use of multiple voltage levels for groupings of electric motors and associated controllers

FIG. 21B is a portion of the block diagram of FIG. 20 illustrating the use of individualized voltage levels for each electric motor and associated controller.

FIG. 22 is a block diagram of one exemplary implementation of a computer and sensor system for dynamically configuring power systems.

Table 1 is an illustration of the impact of auxiliary engine size and the value of “K” on vehicle fuel efficiency.

Table 2 is an illustration of the benefits of tapering engine size within arrays of small engines.

Table 3 is comparison summary of the examples shown in this disclosure illustrating the relative effectiveness of various vehicle power system configurations in increasing vehicle fuel efficiency.

### DETAILED DESCRIPTION OF THE EXEMPLARY IMPLEMENTATIONS

The present disclosure is directed to vehicle power systems. In the following description, numerous specific details are set forth to provide a more thorough description of exemplary implementations of the disclosure. However, it is apparent to one skilled in the art that the disclosure may be practiced without these specific details. In other instances, well known features have not been described in detail so as not to obscure the disclosure.

OK In the following description various exemplary implementations, aspects and characteristics are discussed as directed toward vehicular and particularly automotive applications. The focus on automotive applications is not intended to be, nor should it act as, a limitation to the scope of this disclosure, marine, and air vehicles may also benefit from the disclosure. Automotive also includes automobiles and light duty trucks (terrestrial vehicles), which at present most frequently use single, gasoline burning, ICE power systems to provide power to produce vehicle motion and to operate all vehicle auxiliary and support systems. The automotive focus does not imply that the present disclosure is not applicable for use on other types of vehicles including heavy diesel powered trucks and buses, diesel powered train locomotives, and aircraft.

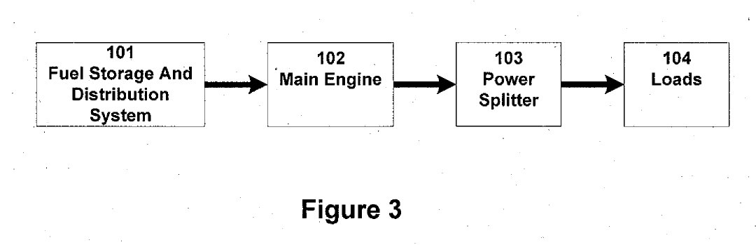

A conventional vehicle power system, illustrated in FIG. 3, shows a functional configuration. A single, large, gasoline main engine 102 provides all of the power required by various loads 104, which are managed as a single loss. Main engine output power is split by a power splitter 103 (such as a pulley and belt system attached to the crankshaft of main engine 102), which diverts a limited portion of main engine 102 output power to auxiliary subsystems.

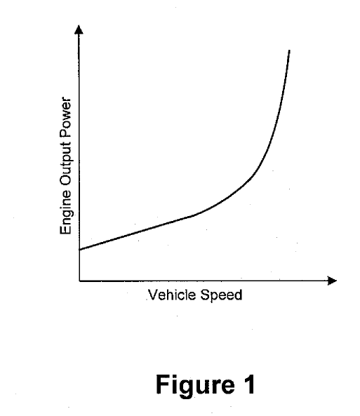

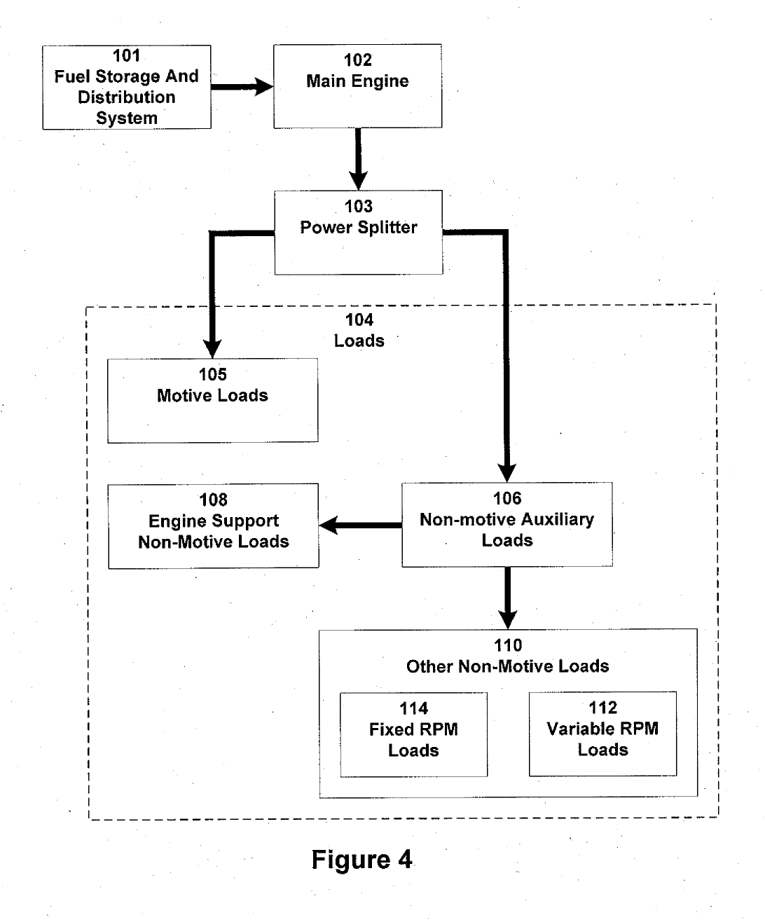

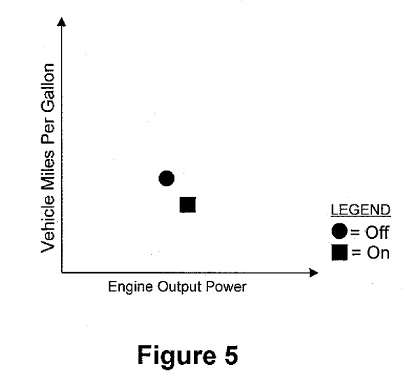

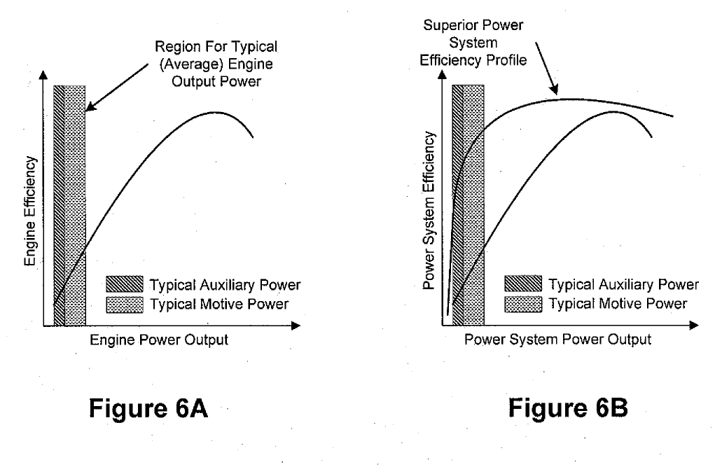

FIG. 4 provides a more detailed view of loads 104. Power splitter 103 directs power to motive loads 105 (load A) for producing vehicle motion and to the non-motive loads 106, which include both engine support non-motive loads 108 and other non-motive loads 110. Subsystems creating engine support non-motive loads 106 can include a water pump (load C), a fuel pump (load J), and a radiator fan (load L). Subsystems creating other non-motive loads can include such items as the electrical system (load B) comprising an alternator, a battery or other means for electrical energy storage, and the electrical power distribution subsystems; power steering pump (load D), air conditioning compressor (load E), and electrical heaters (load F). Engine loads are internal to main engine 102 and not illustrated. Engine loads can include an oil pump (load G), distributor (load H) and camshaft (load 1). An approximation of instantaneous fuel consumption (Fc) for conventional vehicles with such a vehicle power system as illustrated in FIGS. 1-4 is described by equation 1000.

Fc=K(A+B+C+D+E+F+G+H+I+J+L) EQUATION 1000:

wherein “K” is engine fuel consumption per unit load per unit time (typically pounds of fuel per horsepower-hour).

“K” in equation 1000 is not a constant but is the value produced by a complex, multivariable function that is associated with and can serve as a means for characterizing and comparing engines. At a minimum, the value of “K” in one exemplary implementation depends on variables “G”, “H”, “I”, “C” and “B”. The value of “K” also varies with the total engine output power (PTOTAL). Nevertheless, “K” represents a single, measurable value for a specific vehicle configuration under a specific set of operating conditions. A clear characteristic is that a “K” value for a smaller engine is virtually always less than a “K” value of a larger engine operating at comparable power. The nature and implications of “K” on Fc, and the relationship between Fc and vehicle MPG is further discussed below.

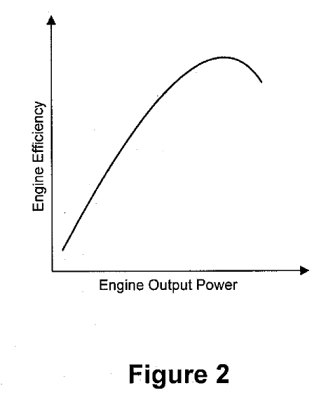

Small gasoline engines have a lower “K” value (consume less fuel per horsepower-hour produced) than larger gasoline engines, particularly when the latter are operating at low output power levels (levels substantially less than the engine maximum). For example, a large engine might have a “K” value of 0.7 at peak efficiency (a high but not maximum power condition per FIG. 2), but under typical load conditions, a large engine might have a “K” value of 1.0-1.8 or more. A small engine might have a “KX” value of 0.2-0.5 at peak efficiency (or even less under unusual circumstances). As in the large engine versus small engine comparison above, the actual “KX” value is heavily dependent on the size of the small engine and relative power output compared to that of its peak efficiency. In general, the small auxiliary engines will be operating much closer to optimum efficiency than the single Primary Engine. This is a difference in “K” values between larger and smaller engines of a similar configuration. Generally, for the same vehicle if one compares a larger engine and smaller engine, operating under performance criteria that include operation within the smaller engines nominal operating range, one will find that the smaller engine is more fuel efficient and normally has reduced pollution produced.

Fc=KAA+KBB+KCC+KDD+KEE+KFF+KGG+KHH+KII+KJJ+KLL EQUATION 1002:

Equation 1002 shows a unique “KX” value associated with each individual load. This condition provides the maximum potential improvement in vehicle fuel efficiency by using a load matched individual engine for each individual load. Examples might be a gasoline powered alternator or air conditioning compressor.

“K” is not a constant over the entire engine operating range, the value of “K” is produced by a very complex, multivariable function wherein said variables may themselves appear in multiple terms in which their impacts may be nearly constant, linear, and non-linear to varying extents, as well as being time varying. A vehicle is a complex system in which the number of actual real world contributors can impact the result. For example, contributors include engine size and vehicle weight but also much smaller variables such as the quantity, composition and distribution of dirt on an air filter. Such air filter dirt can adversely affect the characteristics of the fuel consumption in a major way as can fuel filter clogging, degraded ignition wire insulation, dirty spark plugs, and dirty accumulations within the vehicle exhaust system. The individual characteristics and style of operation by the vehicle operator can also contribute significantly. The individual values of “KX” in equation 1002 are similarly affected.

The typical measure of fuel efficiency for a vehicle is in the form of miles per gallon (MPG). U.S. government regulations require two measures in the form of city and highway MPG, measured under and in conformance with regulated test conditions. The result is effectively a figure-of-merit that allows consumers to effectively compare disparate vehicles from disparate manufacturers, even though the mileage they might actually realize is likely to vary (even considerably) from said published measures. Measurement of MPG is a relatively easy task to perform, requiring data input from only an odometer and a fuel flow sensor. Many vehicles are incorporating instrumentation that allows the vehicle operator to know the near instantaneous MPG and potentially adjust their operating style to raise the MPG or detected degraded performance due to some correctable, physical anomaly within the vehicle.

In an actual vehicle as illustrated in FIGS. 3 and 4, loads 104 can be separated into motive loads 105, which is the cumulated engine loading associated with the production of actual vehicle movement, and non-motive loads 106, which are the cumulated loading for other than direct motion producing systems. The non-motive loads include engine support loads 108 that are external to the engine itself and are not included as part of engine overhead operating power loss. The engine support loads 108 are necessary to engine operation and could have been included as part of overhead losses in an alternate system for load characterization. They are not grouped with engine loads since engine support loads 108 can be independently powered from an auxiliary engine like other auxiliary systems, and thus can similarly improve fuel efficiency in applications of the present disclosure. Engine loads are internal to main engine 102, are equally necessary to operation of the engine, but in contrast, cannot be independently powered.

Engine loads are associated with and include engine mass and crankshaft drive, camshaft drive and valve operation, oil pump drive, distributor drive, air “breathing”, and exhaust gas backpressure. As such, engine loads are clearly not constant and primarily vary with engine RPM. As such, the change in overhead loss between operation at typical loading and full power is relatively small (by a factor of only 2 or 2.5). This largely explains the typical change in engine efficiency versus engine output power shown in FIG. 2. To avoid obscuring the effects of the disclosure, examples in this disclosure will use an overhead loss of four horsepower (hp) unless otherwise indicated.

The impact of engine overhead can be seen in the following example. A vehicle requires 10 horsepower to travel on a level road at 60 miles per hour (MPH) with no wind and an engine overhead loss of 4 horsepower. (Note: air resistance or drag including any wind velocity contribution is a highly nonlinear function of relative air velocity that will be a dominate fuel use factor at high speeds yet be of little significance at low speeds. For even a standard size sport utility vehicle (SUV), 60 MPH typically falls into the top end of the low speed region such that drag can be ignored for this example in favor of linear rolling resistance.) Overall engine efficiency (temporarily ignoring all non-motive loads) is power delivered to the wheel drive system divided by total power generated. For this example, engine efficiency is approximately 10/14 or 71.4%. Operating said vehicle for 1 hour would cover 60 miles. Operating the same vehicle in a lower gear at the same engine RPM could (for purposes of this example) produce a speed of 20 MPH. In this case, engine overhead would remain approximately 4 horsepower but with only 3.3 horsepower delivered to the wheel drive systems (a linear reduction in rolling resistance due to the lower speed) for a total of 7.3 horsepower and an engine efficiency of 45.4%. For a trip of 60 miles, travel at 60 MPH requires 14 horsepower-hours while travel at 20 MPH requires 3 hours and a total of 22 horsepower-hours. Thus vehicle MPG is significantly reduced as a direct result of engine overhead and vehicle MPG decreases with speed reduction to zero when the vehicle is not moving but the engine (and auxiliary loads) remain operating.

The non-motive loads present in real vehicles, which have increased in number, complexity, and total power consumption over time, further reduce vehicle MPG. These loads and their fuel consumption are largely independent of power delivered to the wheels for producing motion. Rather, fuel consumption to power such loads depends primarily on the length of time the auxiliary loads are applied to the power system (i.e. time of operation). For the above example vehicle with 10 horsepower of non-motive loads, engine efficiency in the 60 MPH case is approximately 20/24 or 83.3%, with 24.4 horsepower-hours required to travel 60 miles. For the 20 MPH example, engine efficiency is approximately 13.3/17.3 or 76.9% but 52 horsepower-hours are required to travel the same 60 miles. This example vehicle and the conditions described serve as the baseline shown as item 1 in “Table 3: Summary of Examples for Various Implementations” against which other exemplary implementations are compared. To facilitate comparisons, a single main engine configuration as illustrated in FIG. 3 serves as a baseline with the baseline fuel efficiency (BFE) normalized to 1. Fuel efficiencies for various exemplary implementations are shown as relative fuel efficiency (RFE), which are ratios to the BFE.

The above examples illustrate several important concepts. First, non-motive loads can contribute significantly to overall power consumption even at highway speeds, and such loads may represent a large percentage of engine loading under typical or lower speed driving conditions. Second, total fuel consumption is related to the “K” value and the “K” value directly and linearly impacts MPG at any particular operating point. A lower “K” value results in lower fuel consumption and higher vehicle MPG. Third, lower total fuel consumption enables lower emission of pollutants. By more closely matching power source characteristics with individual loads, power systems have a lower value for “K” and consume substantially less fuel than with conventional power systems.

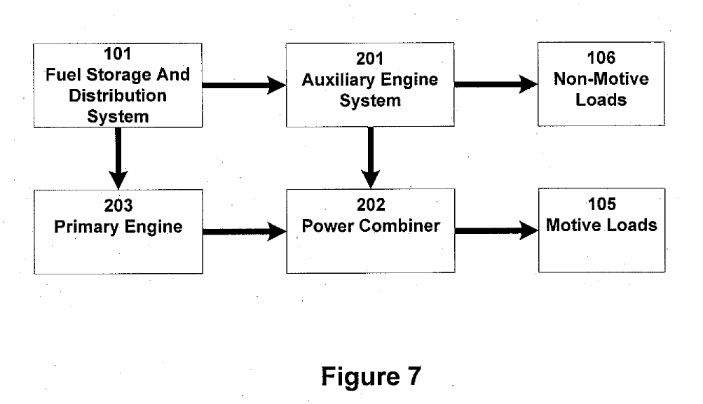

Automobiles and trucks come in a wide variety of sizes, capabilities, and characteristics to satisfy a wide variety of consumer and business needs and desires. The present disclosure can be implemented in whole or in part, and in a wide variety of topologies to meet specified performance and fuel efficiency objectives for a given, specific application. As a result, the term “preferred” loses much of its traditional meaning when both the topological configuration and means of implementation can be heavily determined and constrained by requirements associated with each specific application. Several exemplary implementations, aspects of which may be interchanged as appropriate with aspects of other exemplary implementations disclosed herein, are shown in FIGS. 7, 11, 13, 15, 16, 17, 18, 19 and 22.

One exemplary implementation of a vehicle power system is shown in FIG. 7. A fuel storage and distribution system 101 supplies fuel to more than one fuel-consuming engine. A primary engine 203 and at least one auxiliary engine provide power to the loads of the system. As illustrated the primary engine 203 supplies power through a power combiner 202 to the motive load 105. The one or more auxiliary engines 106 provides power to the non-motive loads 106 and may also provide power, to the power combiner for application to the motive-load 105. Most typically the motive load is the power delivered to a wheel drive subsystem for producing vehicle movement. Motive load is the power actually transferred to the environment through the wheels plus internal power consumed within the wheel drive subsystem.

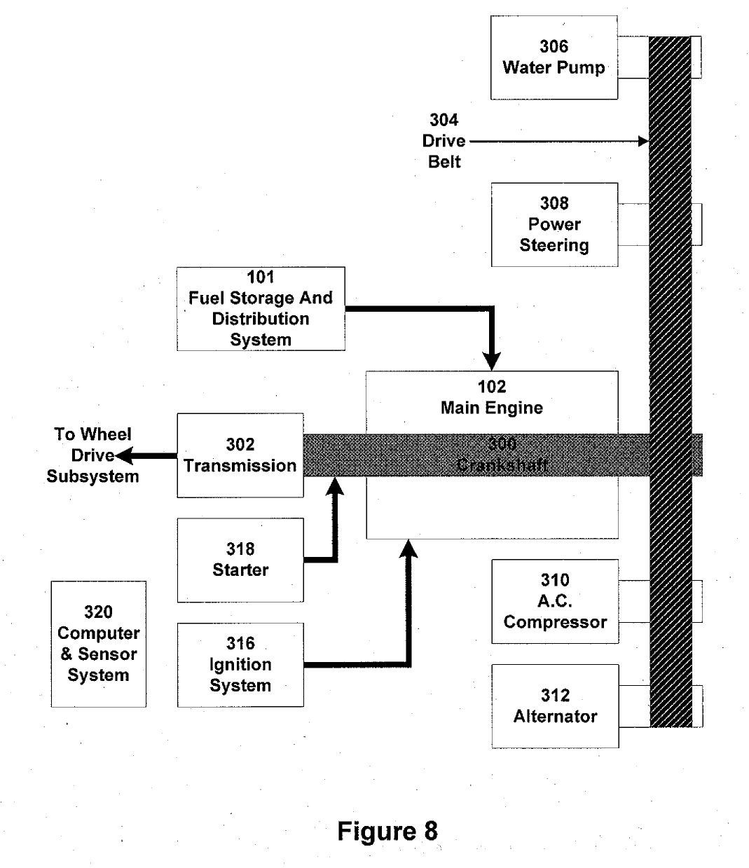

FIG. 8 is a block diagram of a conventional automotive power system, and is included for the purpose of comparison with exemplary implementations disclosed herein. The conventional engine, main engine 102, provides power through crankshaft 300 to the transmission 302 for producing vehicle movement, and to a drive belt 304 to power auxiliary subsystems including water pump 306, power steering 308, A.C. compressor and alternator 312. The alternator 312 charges the battery and supplies power to many of the other non-motive loads 110 described above which include, but are not limited to, all electricity consuming systems.

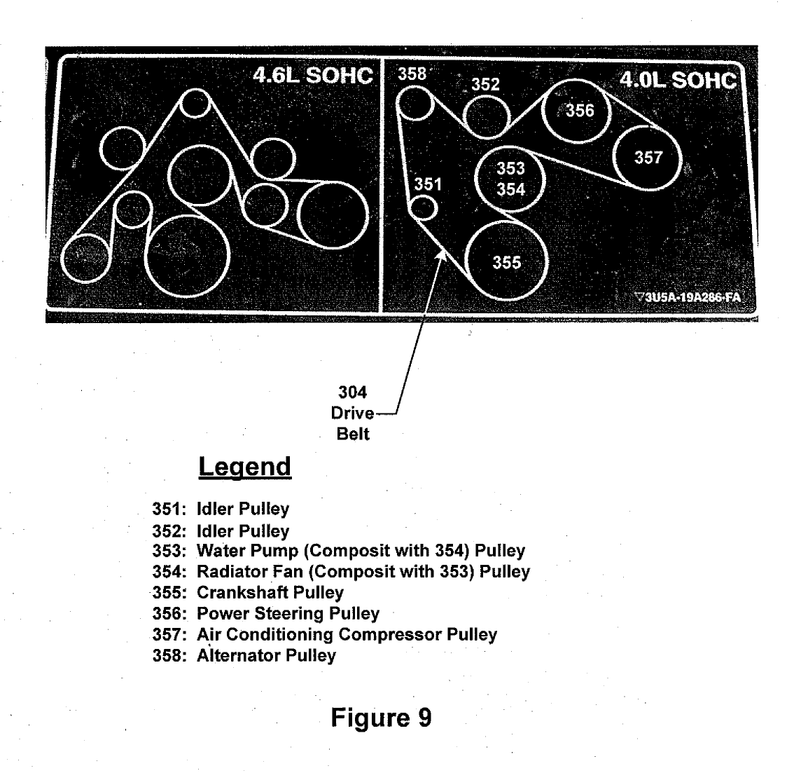

FIG. 9 shows the specific routing for drive belt 304 for the power system illustrated in FIG. 8. The drive belt 304 transfers a portion of the power produced by main engine 102 and provided through crankshaft pulley 355, to water pump pulley 353, radiator fan pulley 354, power steering pulley 356, air conditioning compressor pulley 357 and alternator pulley 358. Idler pulleys 351 and 351 are present to facilitate routing of drive belt 304 and do not transfer power to an auxiliary subsystem.

### A Single Auxiliary Engine, Single Drive Belt

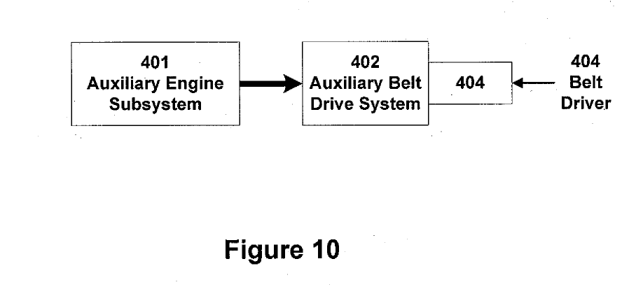

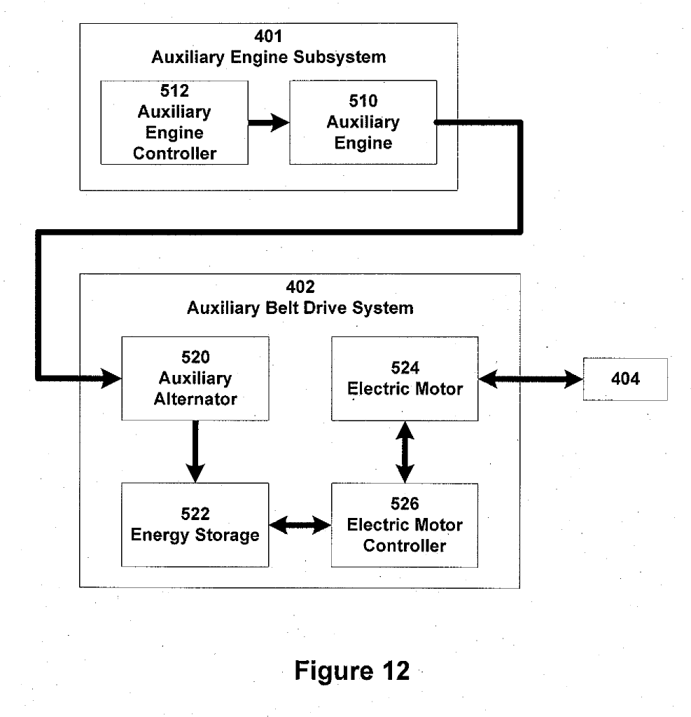

FIGS. 10-12 show the basic function for combining power produced by auxiliary engine subsystem 401 with that from primary engine 203 into a drive belt. An auxiliary engine subsystem 401 powers an auxiliary belt drive system 402, which moves a belt driver 404 and thereby couples power into drive belt 304. The internal functionality of auxiliary belt drive system 402, (see generally FIG. 12) which is shown mechanically driven by auxiliary engine 510. Input power is converted to electrical power by auxiliary alternator 520. Electrical power output from auxiliary alternator 520 can be stored in part in energy storage 522 or passed through it to power electric motor 524 through electric motor controller 526.

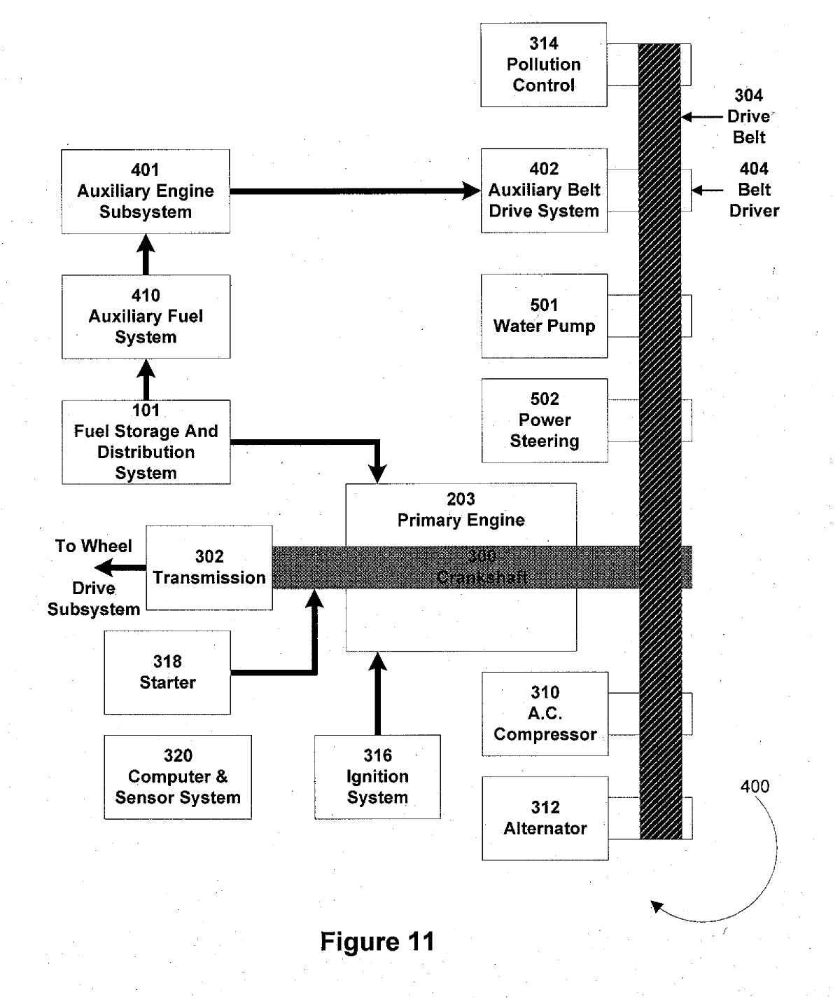

FIG. 11 illustrates an exemplary implementation of a vehicle power system using a single auxiliary engine to provide power to both motive and non-motive loads, single auxiliary engine single drive belt power system 400. In this system, a primary engine 203 can supply power to both the motive loads (transmission 302 and wheel drive subsystem) and non-motive loads including water pump 306, power steering 308, A.C. compressor 310, pollution control 314 and alternator 312. Auxiliary engine subsystem 401 comprising at least one smaller auxiliary engine 510 and an auxiliary engine controller 512 can also provide power to the same motive and non-motive loads as primary engine 203. Generally, for the same vehicle if one compares a larger engine (main engine) and smaller engine (primary engine) plus an auxiliary engine, operating under a performance criteria that includes some operation, over time, within the smaller engines nominal operating range, one will find that for that time period when the smaller engine is engaged and the auxiliary engine is not engaged the system using the primary engine plus auxiliary engine will be more fuel efficient and normally has reduced pollution produced.

Since the implementation of FIG. 11 includes only a single auxiliary engine, the size of auxiliary engine 510 is the most significant factor determining the extent to which the implementation will improve fuel efficiency. In some instances, the amount and location of available volume to be occupied by an auxiliary power system may create restrictions on the size of an auxiliary engine 510. Table 1 indicates the relative potential benefits that could be achieved with different size auxiliary engines. Table 1 is discussed in greater detail below but it is clear that: (1) almost any size auxiliary engine smaller than primary engine 203 will improve fuel efficiency, and (2) optimum improvement is achieved when auxiliary engine size matches the load. Since the “typical” loading can vary significantly with user and application characteristics, it will be very important for vehicle manufacturers to offer a selection of optional auxiliary engine sizes and for users to know both the impact of selected auxiliary systems as well as the manner in which they will typically use the vehicle.

TABLE 1
Impact of Auxiliary Engine Size on Fuel Efficiency

| Item | Auxiliary | Auxiliary | % Aux. | Equiv. | Ratio vs. | |
|---|---|---|---|---|---|---|
| No. | Engine Size | Engine “K” | Power | “K” | Baseline | RFE |
| 1 | None | 0.00 | 0.0% | 1.360 | 1.000 | 1.000 |
| 2 | 1 hp | 0.15 | 5.0% | 1.328 | 0.976 | 1.024 |
| 3 | 2 hp | 0.23 | 10.0% | 1.292 | 0.950 | 1.053 |
| 4 | 4 hp | 0.30 | 20.0% | 1.236 | 0.909 | 1.100 |
| 5 | 6 hp | 0.35 | 30.0% | 1.183 | 0.870 | 1.150 |
| 6 | 8 hp | 0.38 | 40.0% | 1.124 | 0.826 | 1.210 |
| 7 | 10 hp | 0.40 | 50.0% | 1.060 | 0.779 | 1.283 |
| 8 | 12 hp | 0.42 | 60.0% | 0.992 | 0.729 | 1.371 |
| 9 | 14 hp | 0.44 | 70.0% | 0.920 | 0.676 | 1.478 |
| 10 | 16 hp | 0.45 | 80.0% | 0.826 | 0.607 | 1.646 |
| 11 | 18 hp | 0.47 | 90.0% | 0.717 | 0.527 | 1.897 |
| 12 | 20 hp | 0.48 | 100.0% | 0.480 | 0.353 | 2.833 |
| 13 | 22 hp | 0.49 | 100.0% | 0.490 | 0.180 | 2.776 |
| 14 | 24 hp | 0.50 | 100.0% | 0.500 | 0.186 | 2.720 |
| 15 | 26 hp | 0.51 | 100.0% | 0.510 | 0.198 | 2.667 |
| 16 | 30 hp | 0.52 | 100.0% | 0.520 | 0.217 | 2.615 |
| 17 | 35 hp | 0.54 | 100.0% | 0.540 | 0.240 | 2.519 |
| 18 | 40 hp | 0.55 | 100.0% | 0.550 | 0.262 | 2.473 |
| 19 | 45 hp | 0.57 | 100.0% | 0.570 | 0.287 | 2.386 |
| 20 | 50 hp | 0.58 | 100.0% | 0.580 | 0.309 | 2.345 |

Direct combining of power from two, fuel-consuming internal combustion engines (primary engine 203 and auxiliary engine 510 in FIG. 11), which will be operating at different RPM values, is not a practical approach. This situation can be avoided, both for single and multiple auxiliary engine implementations, by utilizing variable speed control as part of the electric motor controller 526. Electric motor 524 is operated in a constant torque mode at a normal RPM that matches and is determined by primary engine 203. The operating mode is a form of master-slave power combining, which can clearly accommodate multiple slave motors and is discussed below relative to combining electrical outputs from multiple auxiliary alternators.

The term “constant torque” in the preceding paragraph means appears to be near instantaneously unchanging torque. It does not imply that the “constant torque” value cannot be adjusted in response to changes in operating load conditions. This capability is useful in maintaining a close dynamic match between power capacity and loading, particularly in implementations having multiple auxiliary engines. Adjustment of the value for the “constant torque” setting is also extremely beneficial in dealing with both engine braking and application of peak additional power, situations in which the “constant torque” setting can be moved up or down in response to inputs such as engine RPM outside a defined range or by detection of manifold pressure or brake application by the vehicle operator.

The benefits of a vehicle power system utilizing a single auxiliary engine single belt power system 400 exemplary implementation can be seen by comparison to the hypothetical vehicle having a conventional power system of the previous example. In the previous example, primary engine 203 has a “K” value of 1.36, and which produces (under typical operating conditions previously described) 10 horsepower for primary drive power and 10 horsepower for auxiliary loads. Fuel usage is calculated as a linear function of delivered power. Overhead power to keep the engine operating under conditions of no external load is ignored, as are highly non-linear loading effects such as wind resistance that can dominate fuel consumption at high speed. The single auxiliary engine 510 has been chosen (per Table 1) to have 24 horsepower and a “K” value of 0.5 (which would be slightly higher due to the fact it is not operating at peak efficiency but this not included as the change is small and added output power is required to overcome losses in the functions converting and delivering the auxiliary engine output power).

The Auxiliary belt drive system 402 has an overall efficiency of 899%, which is comprised of an auxiliary alternator 520 with an efficiency of 97%, energy storage 522 with an efficiency of 98%, electric motor controller 526 with an efficiency of 98%, and electric motor 524 with an efficiency of 97%. With belt driver 404 and drive belt 304 having a combined efficiency of 99.5%, said vehicle power system is estimated to realize an equivalent “K” value of 0.534, or a RFE increase to 2.55 times BFE. Specific efficiency values listed are achievable but may be reduced in a tradeoff between efficiency and cost, which may be offset by selection of an auxiliary engine 510 having a less conservative “K” value. This example is summarized as item 4 in “Table 3: Summary of Examples for Various Implementations” located near the end of this disclosure.

Table 1 is provided to illustrate several aspects of the present disclosure. The auxiliary engine “K” values listed are generated from an equation based on a best logarithmic curve fit for published fuel consumption for several small engines and a 200 horsepower engine in a Ford Explorer, which was estimated to have peak engine efficiency at 150 horsepower and a corresponding “K” of approximately 0.7 (based on measured highway fuel consumption). Item 1 in Table 1 is a conventional power system where Main Engine 102 is said 0.200 horsepower Ford Explorer, whose power system is illustrated in FIGS. 8 and 9. In addition to the previously noted facts that (1) virtually any size auxiliary engine can produce meaningful fuel efficiency improvements, and (2) optimum improvement occurs when the power source output capability matches the typical load, there are several other important characteristics depicted in Table 1.

First, auxiliary engines sized below typical load power will not realize all of the benefits the present disclosure envisions. In this case, the undersized engine is likely to be operating continuously at its predetermined maximum power output. Reliability and derating are issues that need be addressed in a specific design application but are not necessary to this disclosure. Table 1 does indicate that over sizing the auxiliary engine produces substantially better fuel efficiency than under sizing the engine by the same amount.

Second, it should be noted that for cases where the auxiliary engine is sized to provide more output power than typical load power, the added capability reduces fuel efficiency improvement for typical power output. This will be at least partially offset by the fact that the added capacity will provide all or part of excess power required for vehicle acceleration or upgrade operation, improving fuel efficiency under such conditions.

Finally, for the cases where the auxiliary engine is sized to provide more output power than typical load power, it should be noted that the Equivalent “K” value equals the auxiliary engine “K” value. This is not necessarily an artifact as a result of ignoring overhead losses of primary engine 203. Driving crankshaft 300 from an external power source can actually deliver power to engine loads internal to Primary Engine 203. While such engine loads cannot be independently powered, collectively they could be at least partially canceled out. Theoretically, cancellation could be implemented such that there are no net overhead losses associated with primary engine 203. While this might appear attractive from an efficiency point of view, it is neither desirable nor practical for several reasons.

Zero overhead losses imply that no fuel will be delivered to primary engine 203 whenever it is not delivering power (unless fuel is to be deliberately wasted). Under such conditions, a non-operating primary engine 203 cannot function as the “master” in a “master-slave” relationship with the auxiliary engine subsystems. Additionally, overhead losses in a non-operating primary engine 203 would increase many times, likely exceeding the output power capability of typical auxiliary engine subsystems. Finally, a primary engine 203 without fuel delivery might easily appear as an engine that had not been operated for a long period. Such engines frequently require multiple starting attempts and even fuel priming before beginning to operate. Accordingly, it may not be desirable in some situations to have a complete shut down for such an engine i.e. an engine that should be capable of providing motive power, or power to a critical driving systems (as opposed to an air conditioning compressor) as needed in the appropriate time frame. Setting of the minimum output power from the primary engine 203 is discussed further in consideration of these parameters.

### Single Auxiliary Engine, Dual Drive Belt

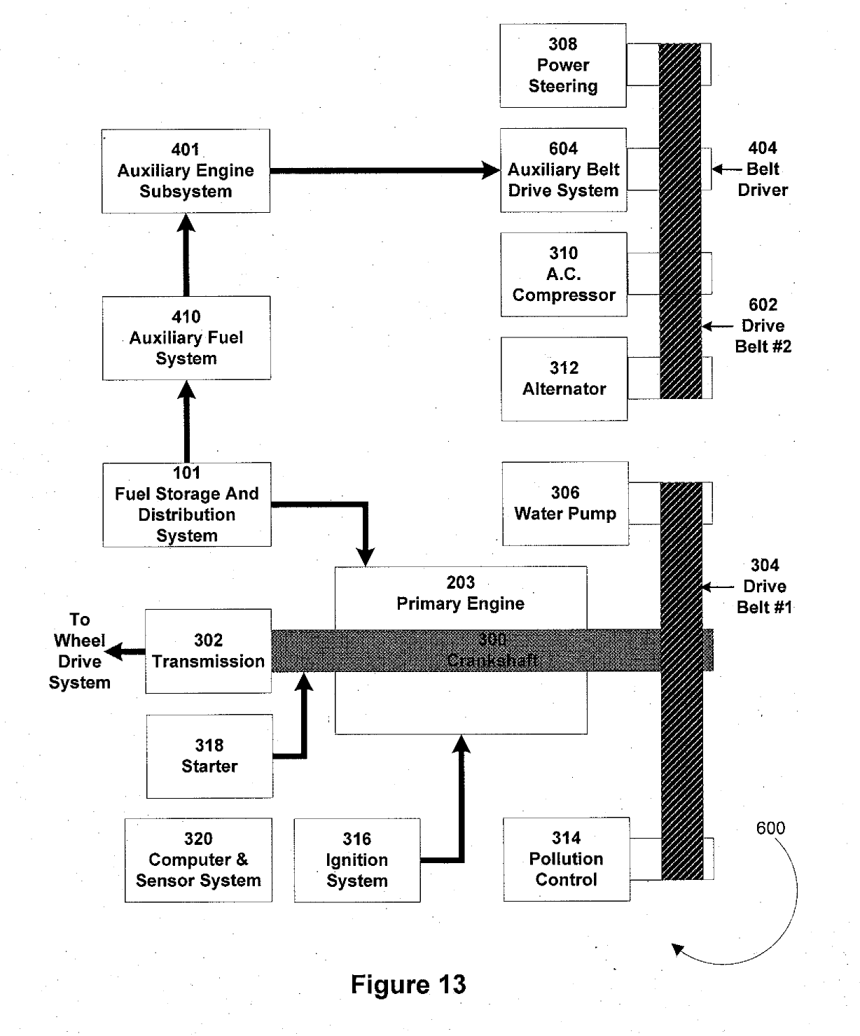

Shown in FIG. 13 is an exemplary implementation wherein power from a single auxiliary engine is used to power one or more non-motive loads but does not provide power to the motive loads 105. This is accomplished by the use of a second drive belt that operates independently from drive belt 304 and provides power coupling between an auxiliary engine subsystem 401 and a selection of one or more non-motive loads only. A block diagram illustrating a single auxiliary engine dual drive belt power system 600 and method of operation. An auxiliary engine subsystem 401 powers an auxiliary belt drive system 604 that moves a belt driver 404. Belt driver 404 moves a second drive belt, drive belt #2 602 within the power system. Unlike the single drive belt Implementation discussed above, neither drive belt is required to transfer more power than in the baseline conventional power system configuration. Maintaining separation between output power from primary engine 203 and the auxiliary engine subsystem(s) 401, totally eliminates the problem of having one fuel-consuming engine drive another fuel-consuming engine (as was illustrated and disclosed in reference to FIGS. 10-12).

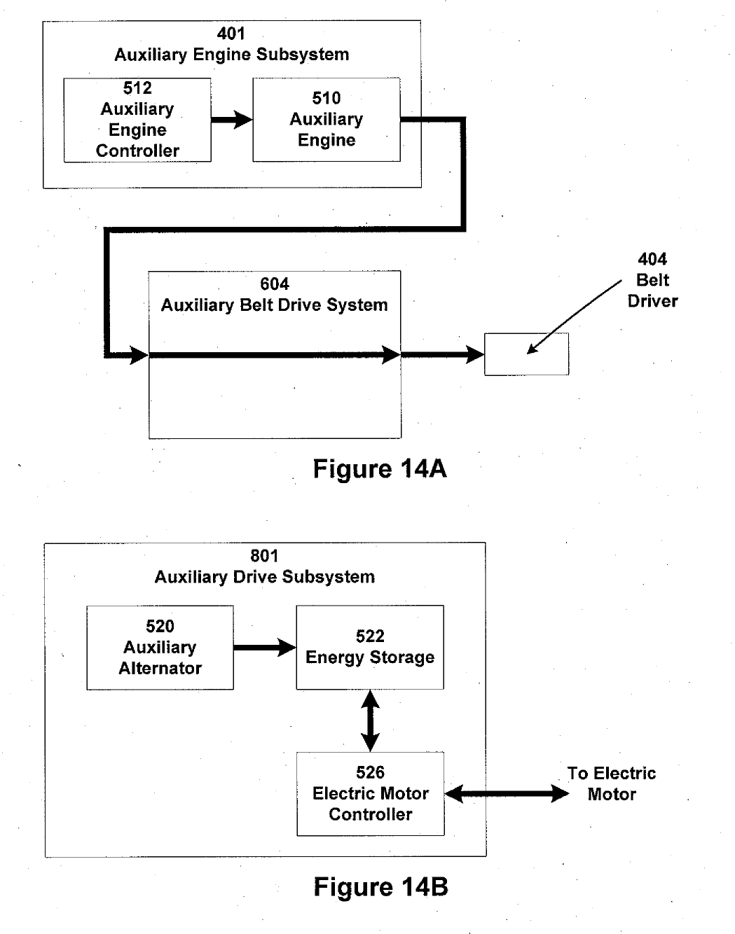

FIG. 14A shows one aspect of the auxiliary engine subsystem 401 and the auxiliary belt drive systems 604 as implemented in single auxiliary engine dual drive belt power system 600. Auxiliary engine subsystem 401 and auxiliary belt drive system 402 are typically implemented as illustrated in FIG. 12. One result of maintaining separation of powers among the multiplicity of engines present is that this provides for the elimination of an auxiliary alternator 520, energy storage 522, electric motor controller 526 and electric motor 524. Auxiliary belt drive system 402 is replaced by auxiliary belt drive system 604, which can be as simple as a single belt pulley that is mechanically attached to or physically part of the crankshaft of auxiliary engine 510.

Another variation of single auxiliary engine dual drive belt power system 600 utilizes two or more auxiliary engine subsystems to power the same or a larger selection of non-motive loads, each of which receives power from only one of the auxiliary engine subsystems. This alternative functions in the same manner as system 600 (only a selection of auxiliary loads are powered by small auxiliary engines but no motive loads). Multiple auxiliary engines supports the use of smaller, potentially more fuel efficient auxiliary engines and the smaller sizes may allow use of previously unusable engine compartment space for installation.

For illustrative purposes, if a 10 horsepower auxiliary engine provides the entire 10 horsepower required by auxiliary subsystems, the effective “K” for the auxiliary engine is 0.40. However, total loading on primary engine 203 is also 10 horsepower providing a “K” value of 1.72 (up from a baseline value of 1.36). The equivalent “K” for the power system is 1.060. This example is shown as item 2 in “Table 3: Summary of Examples for Various Implementations” located near the end of this disclosure. For the case using 2 auxiliary engines of 5 horsepower each, the effective “K” drops to 1.025, which is shown as item 3 in Table 3.

### Dual Auxiliary Engine, Dual Drive Belt

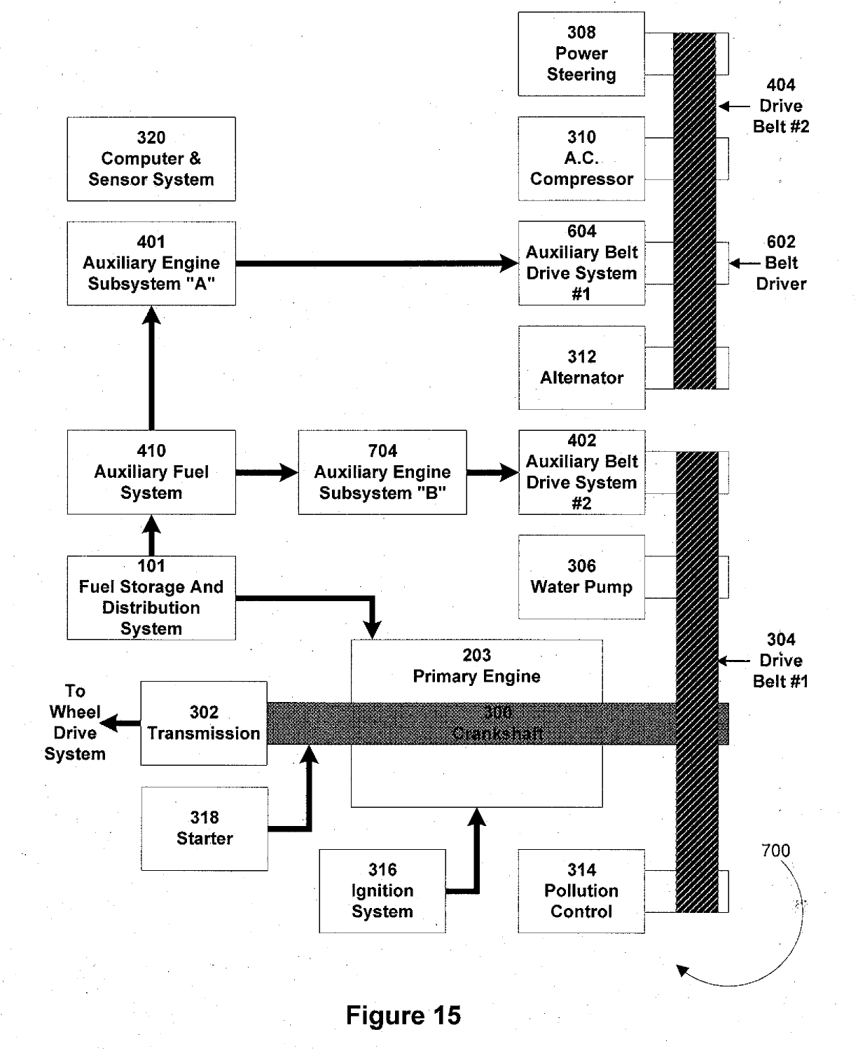

For exemplary implementations having only a single auxiliary engine, Equation 1002 has only two distinct “KX” terms. Other results may be achieved with the use of multiple auxiliary engines. One example of an exemplary implementation with two auxiliary engines is a dual auxiliary engine, dual drive belt power system 700 shown in FIG. 15. The implementation shown in FIG. 15 functions substantially as a simple addition of the implementations of FIGS. 11 and 13 (with any duplicate functions excluded).

For ease of comparison, the auxiliary engine subsystem “A” 401 and the auxiliary belt drive system #1 604 are the same, and drive the same loads as, the auxiliary engine subsystem 401 and auxiliary belt drive system 402 in the implementation shown in FIG. 13. Auxiliary engine subsystem “B” 702 provides a portion of primary drive power (motive loads) to primary engine 203, as well as a portion of engine support non-motive loads associated with primary engine 203. Because auxiliary engine subsystem “B” 702 is sharing a drive belt with the Primary Engine, a master slave relationship is established as described in reference to the single auxiliary engine, single drive belt Implementation described herein. Accordingly at least a variable speed electric motor 524 and an electric motor controller 526 must be included to avoid outputs of two, gasoline engines trying to drive each other at different RPM.

For ease of comparison purposes, water pump 306 will be assumed to require 3 horsepower and pollution control 314 will be assumed to require no power. Auxiliary engine subsystem “A” provides 7 horsepower (“K” value of 0.36) and auxiliary engine subsystem “B” provides 13 horsepower (“K” of 0.43). The equivalent “K” for the power system (for the example conditions and primary engine 203 providing no power) is 0.437. This is a ratio to the normalized baseline of 0.321, and provides an RFE 3.113 times greater. This example is summarized as item 5 in “Table 3: Summary of Examples for Various Implementations” located near the end of this disclosure.

### Direct Electric Motor Crankshaft Drive

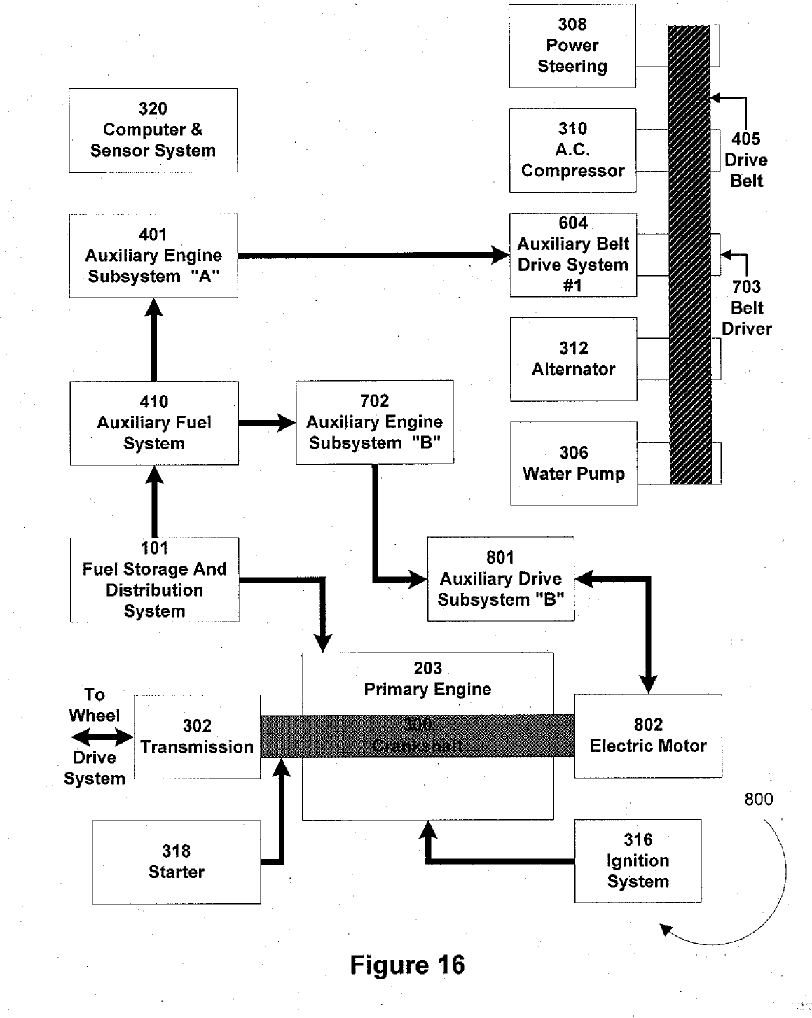

Another method for combining power from an auxiliary engine and primary engine 203 in the crankshaft 300 of primary engine 203 is illustrated in the system 800 shown in FIG. 16. In this implementation, the drive belt is eliminated and one or more auxiliary engines, as within auxiliary engine subsystem “A” 401 in FIG. 16, power all of the non-motive loads excluding engine loads. An electric motor 802 provides the power to be combined with that generated by primary engine 203. The rotor of electric motor 802 is mechanically attached directly to the crankshaft 300 of primary engine 203. This implementation avoids any power transfer limitation imposed by use of drive belt 304, any power loss within drive belt 304, as well as any risk resulting from drive belt 304 failures. Electric motor 802 receives drive power from auxiliary drive subsystem “B” 801, shown in detail in FIG. 14B.

FIG. 16 shows bidirectional connections between auxiliary drive subsystem “B” 801 and electric motor 802, between transmission 302 and the wheel drive system, as well as internal to auxiliary drive subsystem “B” 801. The bidirectional connections (shown in any drawing) indicate normal, bidirectional energy flow or specifically, that the disclosure provides energy recovery during vehicle deceleration. Energy recovery can substantially increase fuel efficiency and is a common feature in AEVs and HEVs. Electric motor drive implementations of the present disclosure can be fully compatible with energy recovery. They only require that the electric motors, motor controllers and energy storage subsystems be capable of returning power to the energy storage subsystem for storage, such as regenerative braking. Electric motor controller 526 is similar to other electric motor controllers of the present disclosure and their operation is discussed below.

Electric motor 802 provides additional power to the crankshaft 300 at whatever RPM primary engine 203 is operating by running in a “constant torque” mode. The “constant torque” operating mode holds for engine RPM up to the maximum output power of electric motor 802. Said maximum output power is preferably a predetermined maximum rating or lower limit set and enforced by the controller, electric motor controller 526 or it is left at simply the maximum output power capability of the specific electric motor. At higher RPM, output power would remain at the maximum value with torque reduced proportionate to the excess RPM. From the point of view of the primary engine 203, it will appear to have a lighter load or the equivalent of the vehicle driving on a roadway that is downhill.

For operation under average load conditions, it would be theoretically desirable to throttle down primary engine 203 such that it delivered zero power. In practice, small errors at such a neutral throttle condition could result in engine braking type operation by primary engine 203, thereby destroying any fuel efficiency enhancement provided by use of an auxiliary engine. It is typically preferable that a throttled down primary engine 203 provide 10% to 15% of power required under typical operating conditions. This power level is small enough that most of the increased fuel efficiency benefits are realized while any potential engine-braking problem is avoided. An added benefit of the configuration in many applications is that electric motor 802 can perform the functions of the starter motor 318 for primary engine 203, providing at least a partial offset for any added cost or complexity associated with implementation of the present disclosure.

Auxiliary power is equally split between auxiliary engine subsystems “A” and “B”. At 10 hp each, auxiliary engine subsystem “A” has a “K” value of 0.40 and auxiliary engine subsystem “B” with associated electrical energy storage and electric motor controls, has a “K” value of 0.442. The equivalent power system “K” is 0.421. This is a ratio to the normalized baseline of 0.310, and provides an RFE 3.229 times greater. This example is summarized as item 6 in “Table 3: Summary of Examples for Various Implementations” located near the end of this disclosure.

### Single Electric Motor Drive Exemplary Implementation

A major limitation on potential fuel efficiency improvement for conventional configurations is the presence of primary engine 203 (see FIGS. 2 and 4). In vehicles with power systems of the present disclosure, the primary engine 203 may contribute little of the total required vehicle power during much of the time said vehicle is in operation. However, though fuel consumption by the primary engine 203 at or near neutral throttle is small compared to operation at maximum power, overhead losses to keep said engine in operation are typically around 3 to 5 horsepower. This 3 to 5 horsepower is not a negligible portion of a typical 20 horsepower total output required to power a lightly loaded vehicle in motion at moderate speed on a level road including substantial operation of the auxiliary systems present. As higher levels of fuel efficiency are realized, consumption by primary engine 203 will become a more dominate fuel consumption factor under typical, light engine load conditions. Furthermore, primary engine 203 consumes fuel far more inefficiently than multiple smaller engines even under conditions of proportionately heavy loading and thus obscures some opportunities for improved fuel efficiency.

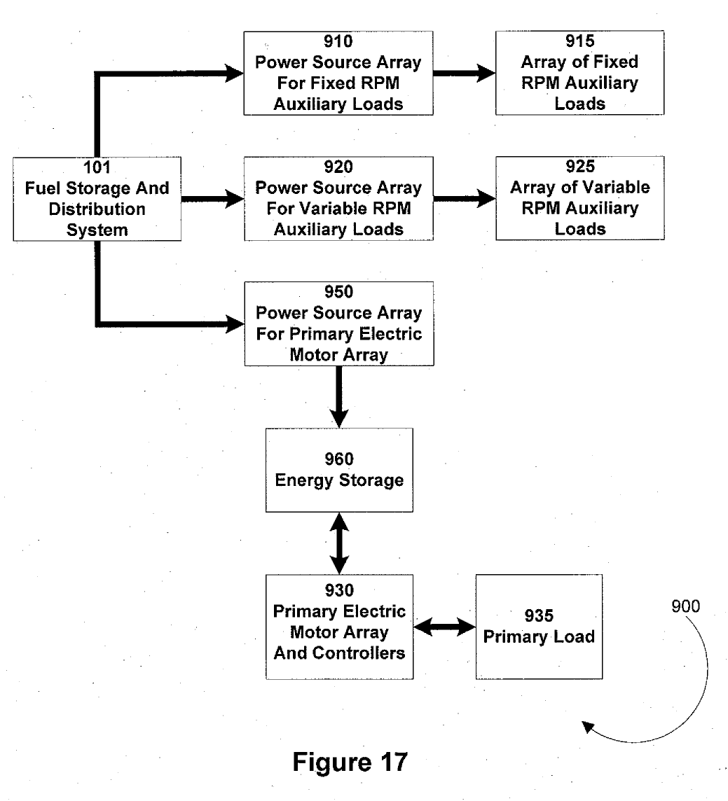

The primary means for avoiding efficiency limitations imposed by the presence of primary engine 203 is to eliminate primary engine 203 by replacing the primary engine 203 with one or more electric motors. One exemplary implementation of an electric drive configuration (EDC) 900 is shown in FIG. 17. Whether a single, large, electric motor (a one element array) or an array of multiple smaller electric motors is used to provide drive power for moving the vehicle, electric motors will typically occupy much less volume than an internal combustion engine with the same peak output power capability, freeing volume for powering both motive and non-motive loads from power source arrays 910, 920 and 950, comprised of multiple smaller, more fuel efficient, ICEs. Loads can be grouped in whatever fashion best facilitates implementation and the intended use. Those of ordinary skill in the art will realize that alternations in either grouping or group size are all within the boundaries of this disclosure. For instance one grouping may be one or more fixed RPM auxiliary loads 915 and one or more variable RPM Auxiliary Loads 925.

Such a system as EDC 900 may utilize one or more primary electric motors 930 to provide power for the motive loads identified as primary load 935. Motive power may be supplied to the primary electric motor array and controllers 930 from one or multiple, small, fuel efficient ICEs comprising power source array for primary electric motor array 950, through energy storage 960.

The sizes of the small ICEs comprising any power source array depend on the number of ICEs comprising the array, the maximum and minimum output power to be supplied by the array, and a selected distribution of power ratings for individual ICEs comprising the array. For example, a 200 hp primary engine 203 might be replaced in a SUV by: (1) four 50 hp engines, (2) unequal engine size distribution such as a binary taper of four engines of 13.5 hp, 27 hp, 54 hp, 108 hp; or (3) a mixed configuration of five engines of 13.5 hp, 27 hp, 54 hp, 54 hp and 54 hp. The reason for tapering is that under typical or average load conditions, power source array for primary electric motor array 950 delivers only a small portion of its maximum capacity, just as with primary engine 203 in previous discussions. Tapering creates the opportunity to deliver required power from a comparably sized source. The potential fuel efficiency benefits of tapering are shown in Table 2 for the above cases.

TABLE 2
Illustration of Engine Size Tapering Impact

| | | | | Total | | Ratio to | |
|---|---|---|---|---|---|---|---|
| | | No. | | Motive | Equlv. “K” | Primary | |
| Item | Case | Engines | Engine Taper (hp) | Power | Value | Engine | RFE |
| 1 | ME 102 | 1 | 200 | 10 hp | 1.720 | 1.000 | 1.000 |
| 2 | 1 | 4 | 50, 50, 50, 50 | 10 hp | 0.986 | 0.573 | 1.744 |
| 3 | 2 | 4 | 13.5, 27, 54, 108 | 10 hp | 0.479 | 0.278 | 3.591 |
| 4 | 3 | 5 | 13.5, 27, 54, 54, 54 | 10 hp | 0.479 | 0.278 | 3.591 |
| 5 | ME 102 | 1 | 200 | 150 hp | 0.696 | 1.000 | 1.000 |
| 6 | 1 | 4 | 50, 50, 50, 50 | 150 hp | 0.580 | 0.833 | 1.200 |
| 7 | 2 | 4 | 13.5, 27, 54, 108 | 150 hp | 0.588 | 0.844 | 1.185 |
| 8 | 3 | 5 | 13.5, 27, 54, 54, 54 | 150 hp | 0.575 | 0.826 | 1.210 |

Table 2 is not intended to define any preferred implementation nor specify actual fuel efficiency improvements associated with any particular application. The table is simply to indicate common characteristics and trends that should be taken into account when configuring a power system for any specific application. First, Table 2 shows that, in accordance with the present disclosure, there is substantial potential for fuel efficiency improvement at both light and heavy engine loads using ICE size tapering. Second, the greatest benefit is obtained by reducing the size of the largest engine actually delivering the output power. Finally, the table shows that inclusion of the smaller engines can have a very large impact on overall fuel efficiency and should not be overlooked. The presence of even one small engine that is actually delivering power can have a surprising impact. Even though Table 2 shows the disclosure impact relative to powering only mobile loads, significant benefit can also be obtained using ICE size tapering on one or more arrays to power auxiliary loads.

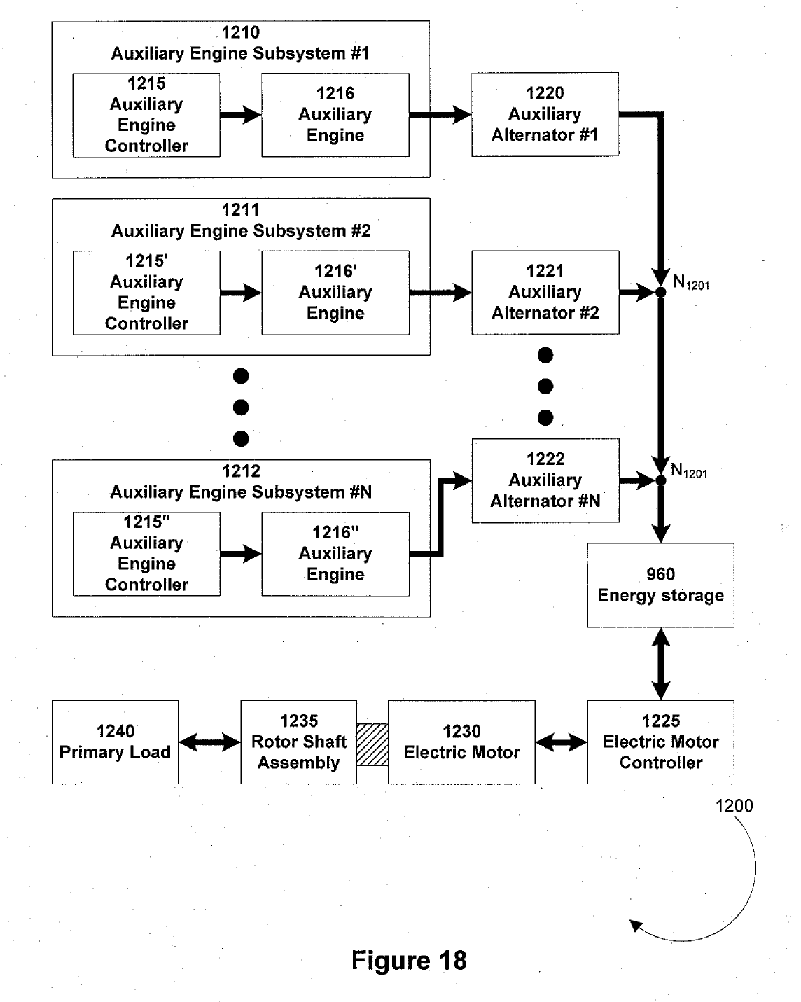

One exemplary implementation of EDC 900 is single electric motor drive 1200 shown in FIG. 18, (see entry 7 in table 3) wherein power source array for primary electric motor array 950 is comprised of multiple auxiliary engine subsystems and corresponding auxiliary alternators. Within each auxiliary engine subsystem, there is at least an auxiliary engine controller 1215, 1215′ and 1215″ and an auxiliary engine 1216, 1216′ and 1216″. Each auxiliary engine subsystem (auxiliary engine subsystems #1 1210 through auxiliary engine subsystem #N 1212) is connected to a corresponding auxiliary alternator (auxiliary alternator #1 1220 through auxiliary alternator #N 1222) whose individual outputs are combined at node N1201 and used to supply motive power by coupling to an energy storage 960 which supplies power to an electric motor controller 1225. Electric motor controller 1225 generates the motor drive currents of proper number, magnitude and form, which are applied to and power electric motor 1230. Electric motor 1230 is coupled to the primary load 1240 via a rotor shaft assembly 1235.

One potential technique to mitigate space limitations, which may be associated with the total available volume, the location of available volume, or other packaging limitations in vehicles, is to power individual auxiliary loads with individual electric motors or engines. Said electric motors and engines are effectively individual elements of a power-generating array with individually dedicated outputs. One example of such an auxiliary load is A.C. compressor 310. While typically powered mechanically via a pulley and drive belt 304 in conventional vehicles, an A.C. compressor 310 can alternatively receive power from either an electric motor or a small ICE, which are integral to the A.C. compressor as discussed previously.

When utilizing a single electric motor and controller 1230, the outputs of auxiliary alternators 1220-1222 must be electrically combined (at node N1201) prior to delivery to energy storage 960 for storage or pass through to electric motor controller 1225. Unlike some other implementation wherein power combining is done mechanically, power combining in this configuration is done electrically. Regardless of method, the combining of power outputs from two or more sources is a characteristic of this disclosure, whether said power outputs are from multiple ICEs or other elements comprising an array of small power sources.

Combining the DC power outputs from multiple electrical power sources, such as auxiliary alternators 1220-1222, is more complex than simply wiring the outputs together at a common node. In such a simplified connection scheme, normal variations in the regulated output voltage will cause one power source to load down others. The result is some sources turned on hard and others virtually unloaded. This potential problem is common whenever distributed electrical power conditioning is employed. A common technique to avoid the problem is designates one of an array of power sources to be a master unit and the others as slaves. The slave units are designed to follow the output of the master in terms of voltage regulation and provide a proportionate percentage of the total load current. Proportionality is important since current outputs should not be equal if engine sizes (and there associated alternators) are tapered in size. If one of the slave devices fails, the other devices simply take up the slack. Failure of the master device does not render the array inoperable since a properly designed slave device can assume the master function. This approach is referred to as a multi-master/slave approach in which there is a prioritized sequence for slave devices to take over the master task. A major benefit of this approach is its inherent redundancy, and it is commonly used in applications where a single point failure of a power system is unacceptable. Examples include computer server systems with hot swap power supplies, certain medical systems, and a variety of space and oceanographic systems where repair is impractical.

Energy storage 960 is comprised of a combination of one or more batteries having the characteristics and energy storage capacity described above, and capacitors to provide for energy storage to satisfy short term transient load applications, filtering of noise and spurious transient signals, and impedance control for maintaining electronic circuit stability. Like most existing automobiles and unlike energy storage in AEVs and HEVs, energy storage is held primarily as a liquid fuel, which represents an exceptionally efficient means of storage. Energy storage in the batteries is limited to an amount sufficient to provide full performance vehicle operation for a short, predetermined maximum time period, which is related to the intended application. Battery power operation in the nature of minutes will be sufficient to provide several repetitions of high-energy usage such as rapid, uphill acceleration for passing another vehicle in the face of oncoming traffic. A typical automotive ICE can be turned on and provide substantially full output power within a short period, much less than a minute (even for implementations that provide for turn-on and turn-off of ICE array elements). Thus electrical energy storage for operation of less than about 1 to 5 minutes will provide substantial operating margin without requiring the use of additional large, heavy and/or expensive batteries or arrays of batteries. Lithium ion or Nickel metal hydride type rapidly rechargeable batteries or a combination of capacitors and batteries may also be used.

Typically, battery recharging will be accomplished using the ICEs that charge the battery during normal operation. However, nothing in this disclosure prevents recharging from other small ICEs that normally drive auxiliary loads (power source arrays 910 and 920), or even from the commercial power grid using an optional plug in capability. Nothing in this disclosure is intended to exclude the vehicle deploying a power system disclosed herein from operating for a significant time on battery power alone. Under these circumstances the vehicle would function in a plug-in hybrid electric vehicle (PHEV) mode with one or more power source arrays either turned-off or powered down for substantial periods of time. This is a particularly useful mode with turn-on/turn-off capable implementations discussed below and allows significant operation even if the vehicle runs out of fuel.

Additionally a single large electric motor could be viewed as a more efficient electric analog to a comparably large ICE. For purposes of this analogy one could chose to view the large electric motor as having its own type of overhead losses associated with largeness thereof. Near rated power, a reasonably efficient electric motor might operate at 95% efficiency while at 10% of rated output power, electric motor efficiency might fall to approximately 60% (or even less). Though both full load and light load electric motor efficiencies are much higher than for the large ICE, a large electric motor's efficiency may also provide improved fuel efficiency compared to some exemplary implementations of the present disclosure.

Major electric motor overhead losses are associated with both the motor controller and the electric motor itself. Controller loses include power semiconductor On-state power dissipation, power semiconductor drive power and controller internal bias power. Drive power for FET or IGBT type semiconductor devices is independent of the actual load, but depends on the input characteristics of the power semiconductors themselves, which are large so as to be capable of delivering maximum peak engine power. Motor losses typically result from internal wiring losses and the minimum magnetizing current at low power. Furthermore, many systems have an absolute minimum power level for stable operation. Those that can operate at loads down to zero typically must compensate by reducing other capabilities and efficiency is one common candidate. In practice, the capability to operate at zero loading is effectively a synthetic load on the power supply.

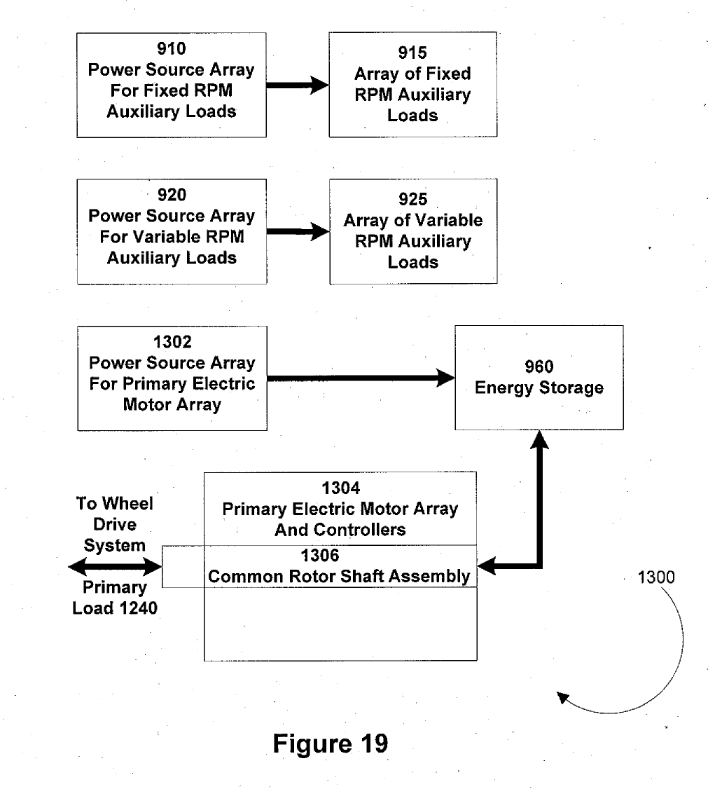

To reduce electric motor inefficiencies it is possible to replace the single large electric motor with an array of two or more smaller, more efficient electric motors as depicted in FIGS. 19-21B and described below in the section titled: “Electric Motor Array Drive Embodiment”.

An exemplary implementation having a single, large electric motor for driving motive loads illustrates the features discussed above and provides a comparative example for both subsequent, multiple electric motor drive exemplary implementations and for previous examples with a large primary engine 203. Motive power is 1.0 horsepower produced by an 8 element array comprised of equal, 25 hp auxiliary engine subsystems. Efficiency of the large electric motor and associated elements is indicated to be 55.9%. Auxiliary power is also 10 hp, produced by a four element array consisting of equal, 2.5 hp auxiliary engines. RFE for this example is increased by a factor of 2.37 compared to BFE. This example is summarized as item 7 in “Table 3: Summary of Examples for Various Implementations” located near the end of this disclosure.

### Electric Motor Array Drive Exemplary Implementation

In some implementations motive power may be generated by a power source array 1300 comprised of small, fuel efficient, ICEs driving high voltage alternators. The outputs from the alternators may be combined and used to both provide energy for storage in energy storage 960 and input electrical power for electric motor controller 1225. The electrical output from energy storage 960 provides input power to the primary electric motor array and controllers 1304 which deploy a common rotor shaft assembly 1306 to deliver power to the primary load 1240, which consists of the wheel drive system.

Although primary electric motor array and controllers 1304 can directly power the wheel drive system, which may include fixed ratio step down gearing, it is typically advantageous to include a variable ratio transmission on the output of primary electric motor array and controllers 1304. The variable ratio enables operation under conditions requiring high torque (such as standing start vehicle acceleration) without excessively high electric motor currents and at high speeds without excessively high electric motor RPM. A variable ratio transmission improves both performance and efficiency for many of the same reasons when used in a conventional vehicle power system.

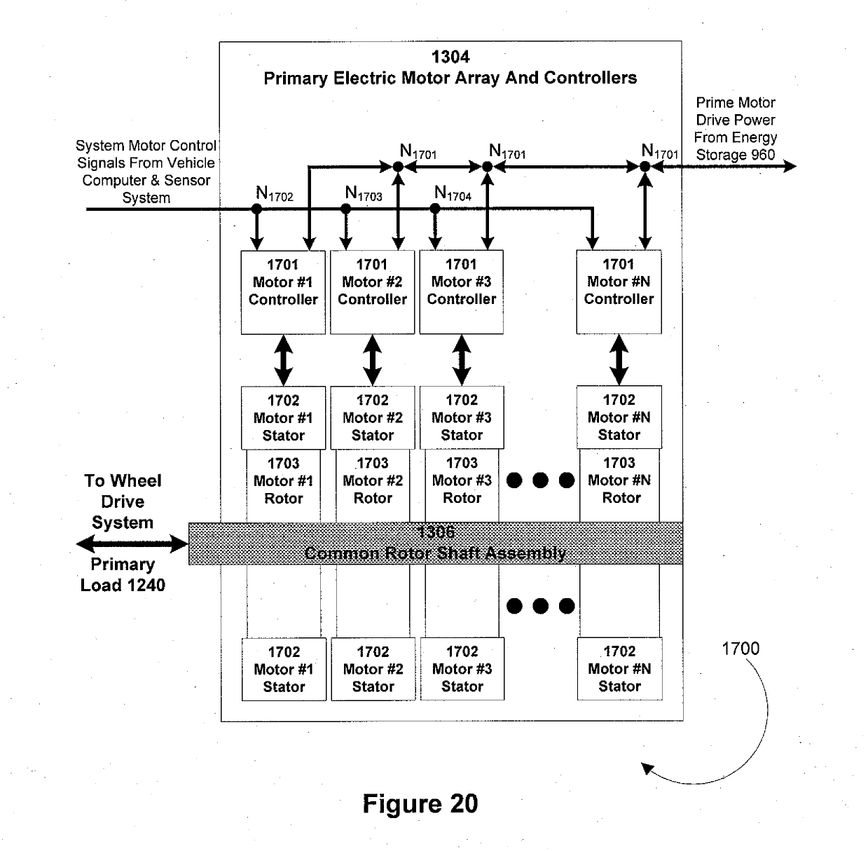

FIG. 20 illustrates a pathway to provide power to primary electric motor array and controllers 1304 shown in FIG. 19. Each electric motor is operated from a common power input at node N1701, which receives power from the energy storage 960. Components within the primary electric motor/engine array and controllers 1402 are typical electric motor elements. A motor controller 1701 communicates with each paired motor stator 1702 1-N and a motor rotor 1-N 1703. The stator/rotor pairs are joined via a common rotor shaft assembly 1306. Nominal power demands are significantly lower than peak demands, the option to engage one or more motors within the motor array provides for selectable on demand power. One aspect of the above-described configuration is the capability to distribute power with wire instead of having to use buss bars. Another aspect is the opportunity to tailor the input voltage value for each individual electric motor comprising common rotor shaft electric motor array and controllers 1304.

An exemplary implementation having an array of electric motors for driving motive loads illustrates the features discussed above and provides a direct comparative example for both subsequent and previous examples shown in Table 3. Motive power is 10 hp produced by an eight element array comprised of equal, 25 hp auxiliary engine subsystems. Efficiency of the electric motors in use and delivering the 10-horsepower with their associated elements is 90.4%. Auxiliary power is also 10 hp, produced by a 4 element array consisting of equal, 2.5 hp auxiliary engines. RFE for this example is increased by a factor of 3.38 compared to BFE. This example is summarized as item 8 in “Table 3: Summary of Examples for Various Implementations” located near the end of this disclosure.

The configuration of the electric motor sub-elements within the electric motor array may be “fine tuned” by deploying a tapering of electric motor element sizes. One configuration of tapering would be a binary progression such as 1 hp, 2 hp, 4 hp, and 8 hp which not only allows finer resolution load matching, but at lower output power levels, provides much of said “typical” power from the smallest and most fuel efficient engines present. This configuration requires some degree of partitioning (power control nodes N1702, N1703 and N1704 are indicated to illustrate the partitioning) to accommodate the different voltages from which the different elements will be operating. For example, it is clearly not desirable to operate a 1 horsepower electric motor and a 100 horsepower electric motor at the same voltage. While this could be accomplished, it would be expected that the 100 horsepower electric motor would be designed to operate optimally at a specific high voltage with maximum load current to magnetizing current ratio of typically 10:1. For a 1 horsepower electric motor operating from the same voltage, the load current would be 100 times smaller and the magnetizing current would be 10 times the load current. Typically, the desired operating voltage for an individual electric motor should scale as approximately the square root of maximum output power.

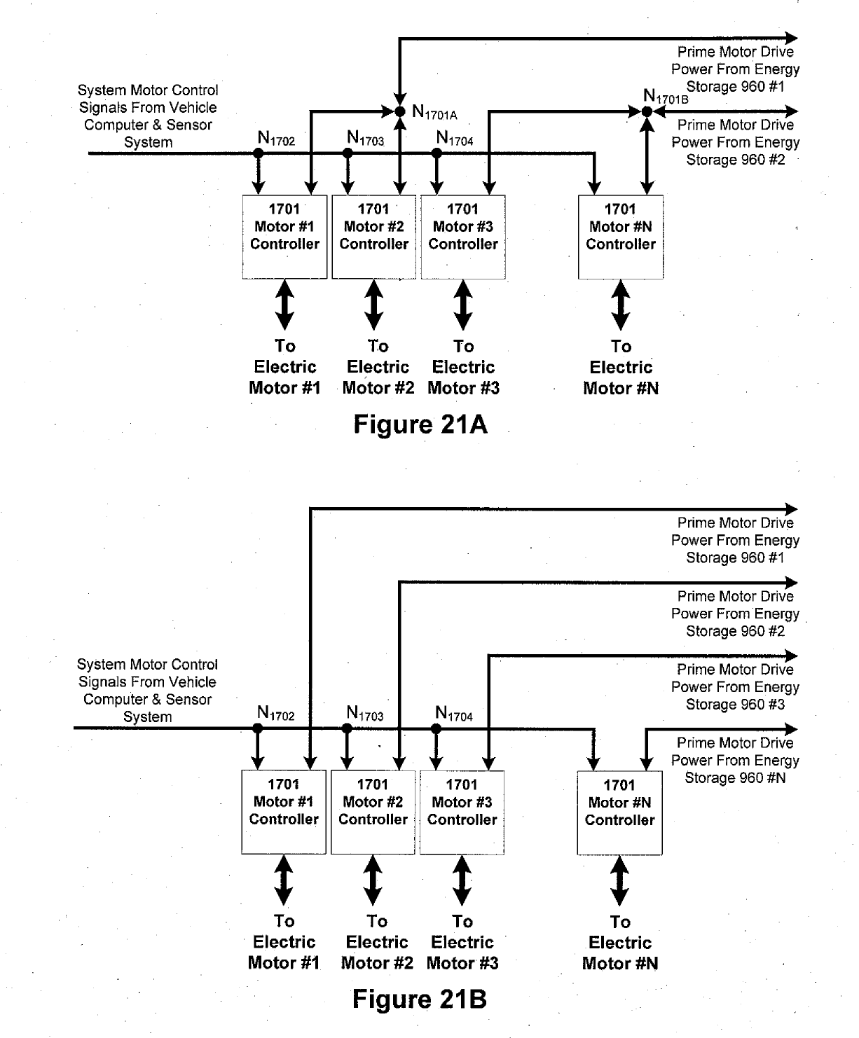

Use of unequal power capacity primary electric motor array and controllers 1304 with unequal operating voltages requires incorporation of a means for generation and distribution of multiple voltage forms as illustrated in FIG. 21A. One option is to generate the required power at multiple voltage levels at one or more nodes (N1701A and N1701B), distribute the multiple voltages to the vicinity of each appropriate element of common rotor shaft electric motor array and controllers 1304, and then regulate the voltage down to the optimum value for each motor element within the array (a motor element comprising a motor controller 1701, motor stator 1702 and motor rotor 1703). Optionally in some designs, it may be preferred to use individualized outputs for each motor controller as illustrated in block diagram FIG. 21B.

An exemplary implementation having tapered arrays of both auxiliary ICEs and electric motors for driving motive loads illustrates the features discussed above and provides a direct comparative example for examples shown in Table 3. Motive power is 10 hp produced by an eight element tapered array, comprised of engine subsystems of 5 hp, 5 hp, 10 hp, 20 hp, 35 hp, 35 hp, 35 hp, and 35 hp. Efficiency of the electric motors in use and delivering the 0.10 hp with their associated elements is 90.4%. Auxiliary power is also 10 hp, produced by a 4 element array consisting of equal, 2.5 hp auxiliary engines. RFE for this example is increased by a factor of 5.62 compared to BFE. This example is summarized as item 9 in “Table 3: Summary of Examples for Various Implementations” located near the end of this disclosure.

### Computer and Sensor System Exemplary Implementation

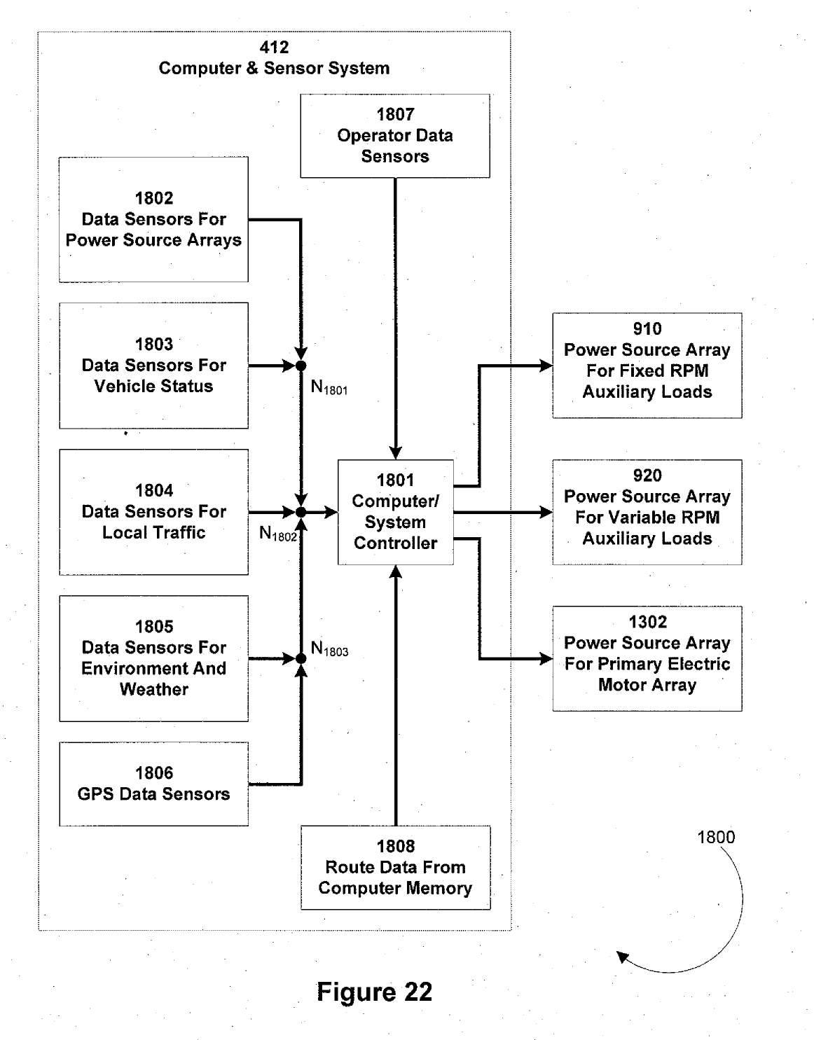

FIG. 22 is a block diagram of one exemplary implementation of a computer and sensor system for dynamically configuring power systems such as that illustrated in FIG. 19. A computer/system controller 1800 is the collection point for data from various sensors, calculates the desired operating condition for the vehicle power system using said sensor data, and transmits control signals to individual engines within power source array for fixed RPM auxiliary loads 301, power source array for variable RPM loads 302, and power source array For primary electric motor/engine array 303 as appropriate. Data and control signals maybe transmitted via individual dedicated wiring, or using a bus structure as illustrated with data sensor connection nodes N1901, N1902, and N1903. Said data bus may be either unidirectional or bidirectional.

Computer/system controller 1801 is preferably a central vehicle computer control. Data sensors are grouped into various categories, which are not intended to be exclusive of others sensor categories. Said categories shown include data sensors “DS” for power source arrays 1802, DS for vehicle status 1803, OS for traffic conditions 1804, DS for environment and weather 1805, GPS DS 1806, operator DS 1807, and route data from WIFI, satellite, cell phone, blue tooth device, DVD, CD and/or accessible memory 1808.

DS for power source arrays 1802 provides information on the present operation of the power system as a whole as well as individual component parts of individual power arrays. DS for vehicle status 1803 one of the most rapidly growing, but until recently, one of the most inadequate of all areas for vehicle data generators. In fact, for many vehicles this category of data sensors is completely absent. The introduction of active suspensions and other ride enhancing features is rapidly increasing the number of sensors in this category.

DS for traffic conditions 1804 can be divided into two groups. The first involves receipt of information communicated from external sources with traffic monitors that are part of the road system. The second group involves information collected by the vehicle itself.

DS for environment and weather 1805 consist of ambient light photo detectors that are used to control vehicle lights. Precipitation, wind velocity, temperature, humidity, air pressure, and road surface conditions and impairments can all be important factors affecting vehicle power system operation. Internet connectable onboard systems allow for access to such content through a plentitude of websites. If not available via Internet access, onboard data sensors can provide such information.

GPS DS 1806 provide real time tracking of vehicle location and where coupled with predetermined route information typically stored as route data 1808 to allow anticipation of near term power system load requirements. An important data item provided is vehicle altitude. Systems providing this information, including map programs and information displays are readily available either as original vehicle equipment, website content or as an aftermarket addition.

The data available from each sensor, data point or memory is, in this implementation, utilized in a predictive (or forecasting) manner. Analyzing elevation over a route, and considering one or more of such items as posted speed, weather and traffic anomalies is available data which may be instructive in predicting the potential output that may be required for a given load under the value ascribed to the set of data associated with the selected items at the point in time the travel is occurring.

For example, once the distance to be traveled under a higher load, such as a steep grade is predicted the system controller can selectively minimize non-critical systems during the climb to impact power requirements and use. Further, if a descent follows such a grade, the system controller can predict regenerative braking (to recharge the energy storage 960) and therefore allow for more usage of energy storage 960 power during the climb of the grade.

TABLE 3
Summary of Examples For Various Implementations
Summary Table of Preceding Illustrative Examples

| | | Large | # Drive Sm. | # Aux Sm. | Ratio vs. | |
|---|---|---|---|---|---|---|
| N | Description | ICE | ICEs | ICEs | Baseline | RFE |
| 1 | Baseline - 1 PE Only | Yes | 0 | 0 | 1.000 | 1.000 |
| 2 | 1 Aux. ICE Aux. Ld Only | Yes | 0 | 1 | 0.779 | 1.283 |
| 3 | 2 Aux. ICE Aux. Ld Only | Yes | 0 | 2 | 0.754 | 1.327 |
| 4 | 1 Aux ICE Common Belt | Yes | ½ | ½ | 0.393 | 2.547 |
| 5 | 1Dr ICE (B) + 1Aux. ICE | Yes | 1 | 1 | 0.321 | 3.113 |
| 6 | 1Dr ICE + 1 Aux ICE | Yes | 1 | 1 | 0.310 | 3.229 |
| 7 | 1 EM Drive (No Tapers) | No | 8 | 4 | 0.422 | 2.369 |
| 8 | 8 EM Drive (No Tapers) | No | 8 | 4 | 0.296 | 3.377 |
| 9 | 8 EM Drive (Tapers) | No | 8 | 4 | 0.178 | 5.623 |

Alterations, changes, and additions may be made in the above systems, methods and processes without departing from the scope of the disclosure herein involved. It is therefore intended that all matter contained in the above description, appended claims and as shown in the accompanying drawing, shall be interpreted as illustrative, and exemplary. It is not intended that the disclosure be limited to the illustrated embodiments.

What is claimed is:

1. A fuel efficient method for powering a vehicle, the method comprising:
Identify the total peak power requirements for a vehicle under a set of performance criteria;
divide the total peak power requirements into at least two subgroups
utilize a primary engine of a size and output to provide for the peak power for one of the at least two subgroups; and,
utilize one or more auxiliary engines of a size and output to provide for the peak power for the remaining one or more subgroups.

2. The method of claim 1 wherein the primary engine has superior fuel efficiency than a single main engine would have when operating over the same defined range.

3. The method of claim 1 wherein the one or more auxiliary engines have superior fuel efficiency than a single main engine would have when operating over the same defined range.

4. The method of claim 1 wherein the combined fuel efficiency of the primary engine and the auxiliary engine system are superior to a main engine operating over the same defined range.

5. The method of claim 1 wherein the auxiliary engines are at least two.

6. The method of claim 5 wherein at least one of the auxiliary engines operates at a substantially fixed RPM.

7. A method to improve fuel efficiency in an automobile, the method comprising:
Identify the total peak load requirements for a terrestrial vehicle under a set of operating criteria;
Divide the identified load requirements under the operating criteria into at least two groups;
Use one or more auxiliary engine subsystems within the terrestrial vehicle to provide power for the load requirements of at least one group;
Use a primary engine within the terrestrial vehicle to provide power for the remaining load requirements, wherein the combined fuel efficiency of the primary engine and the one or more auxiliary engine subsystems under the operating criteria is superior to the fuel efficiency of a single main engine utilized to provide for the peak load requirements of the vehicle.

8. The method of claim 7 wherein the operating criteria include at least one of a distance and a time component.

9. The method of claim 8 wherein over a portion of at least one of time and distance the one or more auxiliary engine subsystems are, for some portion of time or distance, operating at less than full power.

10. The method of claim 7 wherein;
the primary engine provides power for at least motive loads; and
the power output of the at least one of the one or more auxiliary engine subsystems may be selectively combined with the power output of the primary engine.

11. A load matching method for powering an automobile, the method comprising:
Identify the total motive and non-motive loads for a vehicle under a set of performance criteria;
Divide the total loads, which may require power within a automobile during powered movement, into at least two subgroups
provide a primary engine, within the automobile, of a size and with a power output sufficient to provide for at least the motive loads; and
provide one or more auxiliary engine subsystems within the automobile, of a size and with a power output sufficient, to provide for non-motive loads which are not provided for by the primary engine.

12. A fuel efficient system for powering an automobile, the system comprising:
a primary engine of a size and output to supply the power for a predetermined portion of a moving automobile's power requirements which is less than 100 percent of the power requirements;
an auxiliary engine system of a size and output to supply the power for the remaining portion of the moving automobile's power requirements

13. The system of claim 12 wherein the primary engine and auxiliary engine system have superior fuel efficiency than a single main engine with a power supply capacity equal to the combined primary engine and auxiliary engine system when operating over the same defined range.

14. The system of claim 12 wherein the auxiliary engine system comprises at least two auxiliary engines

15. The system of claim 14 wherein at least one of the auxiliary engines operates at a substantially fixed RPM.

16. An improved fuel efficiency automotive power system the system comprising:
an automobile;
a primary engine;
at least one auxiliary engine subsystem and,
the combined “K” value for the primary engine and the auxiliary engine system is lower than the “K” value for a main engine with the same capacity during operation of the automobile.

17. The system of claim 16 wherein during operation the motive power demands of the automobile on the average are between about 5 percent and about 95 percent of the capacity of the primary engine.

18. The system of claim 16 wherein during operation the motive power demands of the automobile are between about 10 percent and about 90 percent of the capacity of the primary engine.

19. The system of claim 16 wherein the non-motive power demands of the automobile are up to about 90 percent of the capacity of the auxiliary engine subsystem.
